(19) United States
(12) Patent Application Publication
(10) Pub. No.: US 2026/0368238 A1
(43) Pub. Date: Nov. 19, 2026

(54) QUESTION-ANSWERING METHOD AND APPARATUS BASED ON LARGE MODEL, DEVICE, AND STORAGE MEDIUM

(71) Applicant: Tencent Technology (Shenzhen) Company Limited, Shenzhen (CN)

(72) Inventors: Xiuhong ZHU, Shenzhen (CN); Lei YI, Shenzhen (CN); Zeqian HUANG, Shenzhen (CN)

(73) Assignee: Tencent Technology (Shenzhen) Company Limited, Shenzhen (CN)

(21) Appl. No.: 19/727,580

(22) Filed: Jul. 1, 2026

Related U.S. Application Data
(63) Continuation of application No. PCT/CN2025/087666, filed on Apr. 8, 2025.

(30) Foreign Application Priority Data
May 24, 2024 (CN) 202410652183.9

(51) Int. Cl. G06F 16/383; G06F 16/334; G06F 40/30; G06N 20/00

(52) U.S. Cl. CPC G06F 16/383; G06F 16/334; G06F 40/30; G06N 20/00

(57) ABSTRACT

A question-answering data processing method, apparatus, and computer-readable storage medium based on a large model for intelligent multimodal response generation. The method obtains session content from at least one round of a question-answering process, where the session content includes text content recording a question from the last round. When the session content includes non-text content, a content relevance between the text content and non-text content is determined. Based on the content relevance satisfying a preset relevance condition, a target response model matching the content modality of the non-text content is selected from a candidate response model set. Response content to the question is generated using the selected target response model based on the session content, enabling modality-aware question answering that adapts to different content types within multimodal conversations.

### CROSS-REFERENCE TO RELATED APPLICATIONS

This application is a continuation application of International Application No. PCT/CN2025/087666 filed on Apr. 8, 2025 which claims priority to Chinese Patent Application No. 202410652183.9, filed with the China National Intellectual Property Administration on May 24, 2024, the disclosures of each being incorporated by reference herein in their entireties.

### FIELD

The disclosure relates to the technical field of computers, the technical field of large models, and provides a question-answering method and apparatus based on a large model, a device, and a storage medium.

### BACKGROUND

With the development of artificial intelligence (AI) technology, large language models (LLMs) have been gradually widely used. The LLM is a relatively complex AI model that may understand and generate human language. The LLM is characterized by its massive scale, ranging from one billion to tens of billions of parameters. The LLM is often applied in scenarios such as text summarization, question-answering, and translation. For example, in a question-answering scenario, a question text may be inputted in a conversational form, and an input question text will be provided to the LLM as a prompt text (prompt). The LLM may generate response content corresponding to the current question text based on the prompt. Since the LLM is a deep learning model trained on massive text data, accuracy of the response content may be greatly improved in the question-answering scenario.

### SUMMARY

Provided are a question-answering data processing method and apparatus based on a large model, a device, a storage medium, and a program product, which can implement intelligent multimodal question answering through content relevance analysis and modality-based response model selection.

According to some embodiments, a question-answering data processing method based on a large model, performed by a computer device, includes: obtaining session content of at least one round of a question-answering process, the session content comprising text content recording a question of a last round of the question-answering process; determining, based on the session content comprising non-text content, a content relevance between the text content and the non-text content; determining, based on the content relevance satisfying a preset relevance condition, a target response model from a candidate response model set, the target response model matching a content modality of the non-text content; and generating response content to the question using the target response model based on the session content.

According to some embodiments, a question-answering data processing apparatus based on a large model, includes: at least one memory configured to store program code; and at least one processor configured to read the program code and operate as instructed by the program code, the program code including: obtaining code configured to cause at least one of the at least one processor to obtain session content of at least one round of a question-answering process, the session content comprising text content recording a question of a last round of the question-answering process; first determination code configured to cause at least one of the at least one processor to determine, based on the session content comprising non-text content, a content relevance between the text content and the non-text content; second determination code configured to cause at least one of the at least one processor to determine, based on the content relevance satisfying a preset relevance condition, a target response model from a candidate response model set, the target response model matching a content modality of the non-text content; and generation code configured to cause at least one of the at least one processor to generate response content to the question using the target response model based on the session content.

According to some embodiments, a non-transitory computer-readable storage medium, storing computer code which, when executed by at least one processor, causes the at least one processor to at least: obtain session content of at least one round of a question-answering process, the session content comprising text content recording a question of a last round of the question-answering process; determine, based on the session content comprising non-text content, a content relevance between the text content and the non-text content; determine, based on the content relevance satisfying a preset relevance condition, a target response model from a candidate response model set, the target response model matching a content modality of the non-text content; and generate response content to the question using the target response model based on the session content.

### BRIEF DESCRIPTION OF THE DRAWINGS

To describe technical solutions in some embodiments or the related art more clearly, the accompanying drawings for describing the embodiments or the related art are to be briefly described below. Apparently, the accompanying drawings in the following description are merely some embodiments, and a person of skill in the art may still derive other accompanying drawings based on the provided accompanying drawings without creative efforts.

FIG. 1 is a schematic diagram of an application scenario according to some embodiments.

FIG. 2 is a schematic flowchart of a question-answering method based on a large model according to some embodiments.

FIG. 3A and FIG. 3B are exemplary diagrams of a question-answering session interface according to some embodiments.

FIG. 4A to FIG. 4C are exemplary diagrams of a content relevance according to some embodiments.

FIG. 5 is a logic schematic diagram of determining actual input content according to some embodiments.

FIG. 6A is an exemplary diagram of a target prompt template according to some embodiments.

FIG. 6B is an exemplary diagram of target prompt content according to some embodiments.

FIG. 7 is a schematic flowchart of determining a multimodal intent recognition result according to some embodiments.

FIG. 8 is a schematic structural diagram of a Transformer model according to some embodiments.

FIG. 9 is a schematic flowchart of an image encoding process according to some embodiments.

FIG. 10 is an exemplary diagram of iterative text prediction according to some embodiments.

FIG. 11 is a schematic flowchart of a training method according to some embodiments.

FIG. 12A is an exemplary diagram of a Prompt template in a training stage according to some embodiments.

FIG. 12B is another exemplary diagram of a Prompt instruction in a training stage according to some embodiments.

FIG. 13 is a schematic flowchart of another question-answering method based on a large model according to some embodiments.

FIG. 14 is a schematic flowchart of a model training process for a text intent recognition model according to some embodiments.

FIG. 15A is an exemplary diagram of a Prompt template in a training stage according to some embodiments.

FIG. 15B is another exemplary diagram of a Prompt instruction in a training stage according to some embodiments.

FIG. 16A is a schematic diagram of a processing flow of a question-answering process according to some embodiments.

FIG. 16B is an exemplary diagram of a question-answering process according to some embodiments.

FIG. 17 is a schematic structural diagram of a video frame encoding and decoding apparatus according to some embodiments.

FIG. 18 is a schematic structural diagram of composition of a computer device according to some embodiments.

FIG. 19 is a schematic structural diagram of composition of another computer device applying some embodiments.

### DESCRIPTION OF EMBODIMENTS

To make objectives, technical solutions, and advantages of this application clearer, the technical solutions in some embodiments will be clearly and completely described below in conjunction with the accompanying drawings in some embodiments. Apparently, the described embodiments are merely a part of some embodiments, rather than all embodiments. Based on some embodiments, all other embodiments derived by a person skilled in the art without creative efforts fall within the protection scope of this application. Provided that no conflict exists, the embodiments in this application and features in the embodiments may be mutually combined in different manners to form other embodiments. Moreover, although a logic sequence is shown in a flowchart, the illustrated or described operations may be executed in a sequence different from the description here in some circumstances.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

For ease of understanding the technical solutions provided in some embodiments, some key terms used in some embodiments are first explained herein.

Language model: It is a model configured for modeling a nature language, and an objective of the model is to predict a next word or character of a given text sequence. The language model may be applied to multiple natural language processing tasks, such as semantic extraction of text, text generation, machine translation, and speech recognition. Pre-trained language models (PLMs) based on Transformer are common in various tasks of natural language processing, and generally achieve relatively good effects. For example, common PLMs include a bidirectional encoder representation from transformers (Bert) model and a generative pre-trained transformer (GPT) model.

Large language model: it may be referred to as a large model, a natural language model, a large-scale language model, or the like. It refers to a natural language processing model having large-scale parameters and training data. A training process of the large language model usually adopts an unsupervised learning manner, that is, training the model through a large-scale text corpus, thereby learning a language probability distribution and language rules. During the training process, the large language model usually adopts a language model as an objective function, that is, optimizing model parameters by maximizing a prediction probability of a next word. For example, a GPT series model based on a Transformer model structure is trained on a large-scale corpus, and may generate high-quality natural language text such as articles and dialogues.

Content modality: In some embodiments, each medium form or carrying mode of information may be referred to as a modality. For example, audio, videos, images, and text may each be referred to as a modality. In the field of artificial intelligence (AI), multimodality refers to an ability to combine and use a plurality of different medium forms (which may be referred to as input or output modes). That is, an AI system is capable of understanding and processing a plurality of types of data.

Content relevance: In some embodiments, the content relevance refers to a relevance between session content and non-text content involved therein during a question-answering process, for example, a relevance between text content and non-text content. The relevance may indicate whether the non-text content is relevant to the session content, or may be understood as a degree of dependence on the non-text content when responding to a question in the last round. When the degree of dependence is high, it indicates that responding to the question depends on the non-text content, and subsequent processing needs to be performed according to the non-text content. When the degree of dependence is low, it indicates that an influence of the presence or absence of the non-text content on responding to the question is not significant.

Pre-trained model: It refers to a model obtained by training on a large-scale corpus, and usually uses an unsupervised learning method, for example, an autoencoder or a language model. A idea of a pre-trained model is to utilize a large-scale corpus to enable the model to learn a large amount of general knowledge and regularities through an unsupervised learning method, thereby serving as a base model for various natural language processing tasks.

Transformer: It is a common deep learning model architecture and is widely applied to various fields such as natural language processing, computer vision (CV), and speech processing. When originally proposed, the Transformer is a sequence-to-sequence model architecture configured for machine translation, and includes an encoder and a decoder. The encoder and the decoder each include a series of Transformer blocks with the same structure. Each transformer block includes at least a multi-head self-attention layer and a feed-forward neural network layer. The Transformer has become a common architecture in natural language processing and is usually used as a pre-trained model. In addition to language-related applications, the Transformer is further applied to fields such as CV and audio processing.

Prompt learning: It is a natural language generation technology based on human prompts. Additional text is added to an input segment to better utilize knowledge of a pre-trained language model, so as to improve generation quality and efficiency of a finally generated model. A idea is that, during a generation process, a human prompt or a partially generated result is given, referred to as a prompt token, or referred to as a prompt text (prompt), representing a command or an instruction for indicating an action to be performed or an output to be generated using a large language model, so that the model continues to generate text on this basis. Prompt learning may be applied to various natural language generation tasks, for example, text summarization, machine translation, and dialogue generation. Prompt learning may help the model better understand a context and context of a generation task, thereby generating more accurate and natural text, improving generation quality and efficiency of a generation model, reducing a generation space of the generation model, and improving generation efficiency and speed.

Fine-tuning: It may be referred to as fine-tuning training, and refers to further training a model based on a pre-trained model by using a data set, so as to adapt to a task or domain. Therefore, the fine-tuning may be referred to as adaptive training, which may finally improve performance and effect of the model on the task. A prompt learning process usually involves fine-tuning, so as to enable a model to better understand a prompt text and a context and context of a generation task, thereby generating more accurate and natural text. For example, a mode of fine-tuning is supervised fine-tuning (SFT) training.

Attention mechanism: It is a mode of measuring intermediate features of a network using advanced information to cause the network to focus on partial information in an image that assists determination, and ignore irrelevant information. An essence of the attention mechanism comes from a human visual attention mechanism. Generally, when perceiving a thing through vision, people do not view the whole thing from beginning to end every time, but often observe and pay attention to a part according to requirements. In addition, when people find that a thing they want to observe often appears in a part of a scene, people learn to focus attention on that part when a similar scene appears in the future. Therefore, the attention mechanism is essentially a means for screening high-value information from a large amount of information. In the large amount of information, different information has different importance to a result, and the importance may be reflected by assigning weights of different values. In other words, the attention mechanism may be understood as a rule of distributing weights when a plurality of sources are combined. Generally, the attention mechanism may be configured for resolving a problem that it is difficult to obtain a final proper vector representation when an input sequence of a model is relatively long. An intermediate result of the model is retained, a new model is used to learn the intermediate result, and the new model is associated with an output to screen the information. The attention mechanism includes an attention mechanism, a self-attention mechanism, a single-head attention mechanism, a multi-head attention mechanism, and the like.

Solutions provided in some embodiments relate to generation of response content for a question raised in a question-answering process in the question-answering field. During generation of the response content, the solution provided by some embodiments allows a user to add non-text content, for example, an image, when raising a question, so as to enrich information included in input content. Therefore, before generating the response content, it is first necessary to determine, according to the technical solution provided by some embodiments, whether a response to a current question needs to depend on the non-text content, that is, to determine a content relevance between the question and the non-text content, thereby determining actual input content inputted into a large model for generating the response content. Moreover, a target response model needed is determined according to a current content intent. The target response model is configured for generating the response content. In determining the content relevance and determining the target response model, an artificial neural network model based on deep learning needs to be used. Taking the determining the content relevance as an example, some embodiments adopt a machine learning method and a prompt learning-related method for a pre-trained model, to obtain a multimodal intent recognition model capable of determining the content relevance. The multimodal intent recognition model determines the content relevance between the session content and the non-text content based on an ability implemented through machine learning to process and understand a correlation and a semantic relationship between the session content and the non-text content in a question-answering scenario.

In some embodiments, determination of the content relevance and determination of the target response model may be divided into two parts, including a training part and an application part. The training part relates to the technical field of machine learning. In the training part, some embodiments adopt training data in the question-answering field, perform prompt learning on a pre-trained language model, and continuously adjust model parameters through an optimization algorithm until the model converges, so that a fine-tuned pre-trained language model is adapted to the question-answering field and may better understand a context and context of a determination task of determining the content relevance and determining the target response model in the question-answering field, thereby generating more accurate task results. The application part is configured for using an artificial neural network model obtained through training in the training part to perform multimodal intent recognition on text content and non-text content inputted during actual use, and determining, based on a multimodal intent recognition result, a finally used target response model, so as to generate response content through the target response model. In addition, the artificial neural network model in some embodiments may be trained online or offline. This is not specifically limited herein. In this specification, offline training is taken as an example for illustration.

The related art provides a pure text intent recognition model framework. In this architecture, input content of one round of question-answering process includes only text content, so that only the text content may be used as a prompt text to generate corresponding response content. In a question-answering scenario, the prompt text is a main basis for generating response content. Therefore, the richer and more accurate information the prompt text provides, the higher accuracy of response content generated using a large language model. However, in the related art, the prompt text is limited to a single dimension of text, and the text dimension may provide only limited information, restricting accuracy of the response content.

Based on this, some embodiments provide a question-answering method based on a large model. In this method, rather than being limited to a single text dimension, a content input of multiple content modalities may be supported during a question-answering process, so that the question-answering process may be performed based on non-text content modalities such as pictures, videos, or audio, thereby expanding usage scenarios of the question-answering process. Moreover, introduction of multimodal content enables different forms of information to be expressed through different content modalities, making information expression more diverse, thereby providing richer information to a large model, helping improve accuracy of the large model in understanding input content, generating more accurate response content, and improving accuracy of the response content. In a question-answering process, when session content includes non-text content, the method of some embodiments performs multimodal intent recognition on the session content and the non-text content. A multimodal intent recognition result indicates a content relevance between the session content and the non-text content, thereby enabling selection of a matching target response model based on the content relevance, improving accuracy of a selected response model, and further improving accuracy of the response content.

In addition, in some embodiments, based on a model pre-trained by using an SFT training method, fine-tuning training is further performed to enable a finally obtained model to better adapt to tasks in a current question-answering scenario, for example, a multimodal intent recognition task and a text intent recognition task, so as to improve accuracy of a task result in the question-answering scenario, and finally improve accuracy of response content.

Application scenarios to which the technical solutions of some embodiments may be applied are briefly described below. The application scenarios described below are merely for illustration of some embodiments, rather than for limitation. In a implementation process, the technical solutions provided by some embodiments may be flexibly applied according to actual needs.

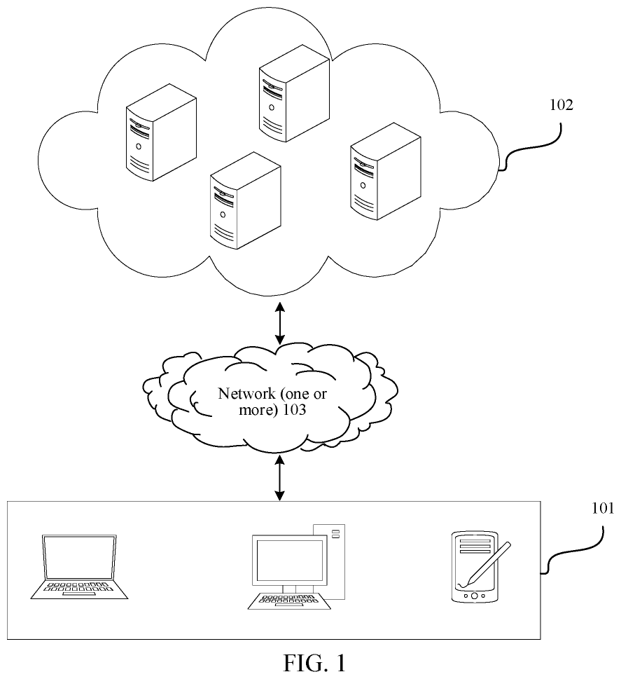

The solution provided by some embodiments may be applicable to a question-answering scenario. FIG. 1 is a schematic diagram of an application scenario according to some embodiments. In this scenario, a terminal device 101 and a server 102 may be included.

For example, the terminal device 101 may be a mobile phone, a tablet computer (PAD), a notebook computer, a desktop computer, a smart television (such as a smart television), an intelligent in-vehicle device, an intelligent wearable device, an aircraft, or the like. The server 102 may be, but is not limited to, an independent physical server, a server cluster or distributed system including a plurality of physical servers, or a cloud server providing cloud computing services such as a cloud service, a cloud database, cloud computing, a cloud function, cloud storage, a network service, cloud communication, a middleware service, a domain name service, a security service, a content delivery network (CDN), and a big data and artificial intelligent platform.

The method of some embodiments may be separately performed by the terminal device 101 or the server 102, or may be jointly performed by the server 102 and the terminal device 101. When separately performed by the terminal device 101 or the server 102, both a model training process and an application process may be separately implemented by the terminal device 101 or the server 102. For example, on the terminal device 101, a trained multimodal intent recognition model and a text intent recognition model may be obtained by performing fine-tuning training on a pre-trained large language model through a collected question-answering sample set. Accordingly, after training, the terminal device 101 may use a trained multimodal intent recognition model to recognize a content relevance between text content and non-text content in a last round of question-answering process, so as to perform the last round of question-answering process based on the content relevance. In some other embodiments, the server 102 may perform the foregoing process. When jointly performed by the server 102 and the terminal device 101, the server 102 may train a multimodal intent recognition model, and then deploy a trained multimodal intent recognition model to the terminal device 101, so that the terminal device 101 implements a question-answering process. In some other embodiments, a partial process of a model training process or an application process may be implemented by the terminal device 101, and another partial process may be implemented by the server 102, so that both cooperate to implement the model training process or the application process. In practical applications, configurations may be made according to actual situations. This is not specifically limited in this application herein.

The server 102 and the terminal device 101 may each include one or more processors, a memory, an interactive input/output (I/O) interface, and the like. In addition, the server 102 may further be configured with a database. The database may be configured to store model parameters obtained through training. The memory of the server 102 and the memory of the terminal device 101 may further have program instructions to be executed in the question-answering method based on a large model provided by some embodiments stored therein. When executed by a processor, these program instructions may be configured for implementing a model training process or a question-answering process based on a large model provided by some embodiments.

When the question-answering method based on a large model provided by some embodiments is separately performed by the server 102 or the terminal device 101, the foregoing application scenario may include only the server 102 or the terminal device 101, or the server 102 and the terminal device 101 may be considered as the same device. Certainly, in practical applications, when the question-answering method based on a large model provided by some embodiments is jointly performed by the server 102 and the terminal device 101, the server 102 and the terminal device 101 may be the same device. That is, the server 102 and the terminal device 101 may be different functional modules of the same device, or may be virtual devices virtualized by the same physical device.

For example, a user may provide input content through the terminal device 101 to initiate a round of question-answering process, so that the server 102 may receive the input content provided by the user, and then generate response content of a last round of question-answering process based on session content by using the method of some embodiments, and return the response content to the terminal device 101 for presentation.

In some embodiments, the terminal device 101 and the server 102 may be in direct or indirect communication connection through one or more networks 103. The network 103 may be a wired network or a wireless network. For example, the wireless network may be a mobile cellular network, may be a wireless-fidelity (WIFI) network, or certainly may be another possible network. This is not limited in some embodiments. FIG. 1 is merely an example for illustration. Actually, a quantity of terminal devices and a quantity of servers are not limited, and are not specifically limited in some embodiments.

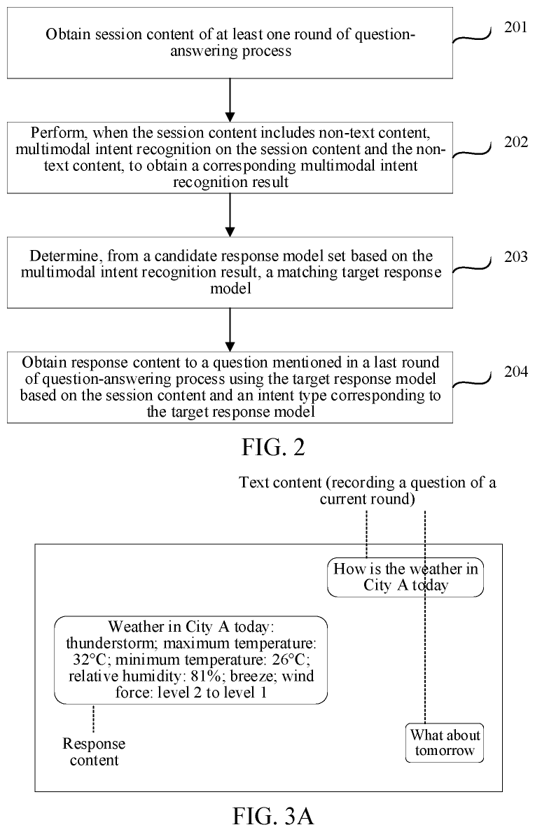

FIG. 2 is a schematic flowchart of a question-answering method based on a large model according to some embodiments. The method may be performed by a computer device. The computer device may be, for example, the terminal device or the server shown in FIG. 1. The method may include the following operations.

Operation 201: Obtain session content of at least one round of question-answering process, the session content at least including: text content recording a question of a last round of question-answering process.

The method in some embodiments may be applied in a question-answering scenario. In the question-answering scenario, a user may input a question, and accordingly, a large model may provide corresponding response content for the user according to the question. After the user submits a question of one round of question-answering process, session content of at least one round of question-answering process including the round of question-answering process may be obtained. The at least one round of question-answering process may refer to the last round of question-answering process, or may include the last round of question-answering process and at least one previous round of question-answering process. The question-answering scenario may be any scenario providing a question and providing response content according to the question, and may be, for example, a scenario of retrieval, knowledge question-answering, a question-answering robot, or an AI assistant.

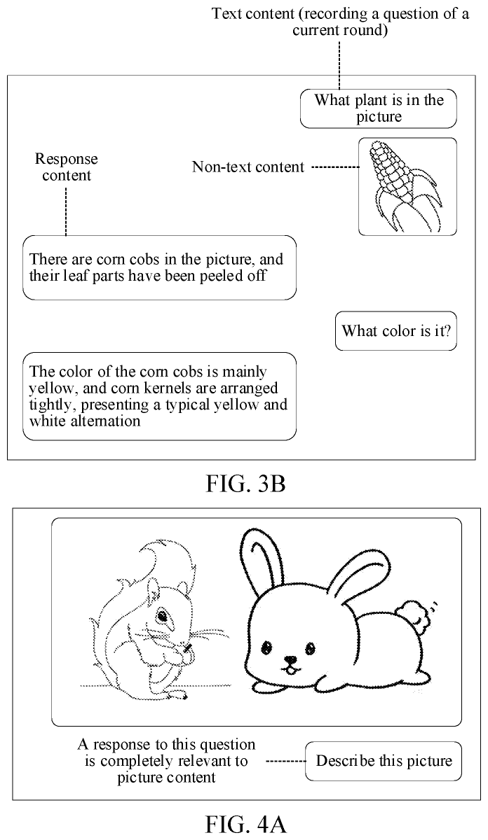

FIG. 3A and FIG. 3B are exemplary diagrams of a question-answering session interface according to some embodiments. The question-answering process may be performed in a session mode. A user may provide input content through a session interface to implement interaction with a large model. If a mode shown in FIG. 2 is performed by a terminal device, after the user provides input content on the session interface of the terminal device. The terminal device may perform a subsequent method flow according to the input content to obtain corresponding response content, and present the response content on the session interface. If the method shown in FIG. 2 is performed by a server, after the user provides input content on the session interface of the terminal device, the terminal device may transmit the input content to the server. The server may perform a subsequent method flow according to the input content to obtain corresponding response content, and return the response content to the terminal device, so that the terminal device presents the response content on the session interface.

FIG. 3A illustrates a session interface in a pure text scenario. In the pure text scenario, input content of a user includes only text content, and all information comes from the text content. However, information expressed by the text content is limited, restricting application of the question-answering scenario. Therefore, some embodiments provides a question-answering method supporting non-text content. Referring to FIG. 3B, a user may input non-text content in a session interface. Taking an image in FIG. 3B as an example, the image may vividly describe content that cannot be expressed by the text content, making information covered by the input content richer, and helping a large model provide more accurate response content.

In some embodiments, the session content includes input content and response content involved in at least one round of question-answering process. Taking FIG. 3A and FIG. 3B as examples, the input content in some embodiments may include, but is not limited to, the following content.

(1) Text content: The text content records a question of one round of question-answering process. Certainly, in addition to the question, other descriptive content may further be included, to serve as auxiliary content for responding to the question. As shown in FIG. 3A, “How is the weather in City A today” and “What about tomorrow” are text content, and as shown in FIG. 3B, “What plant is in the picture” and “What color is it” are also text content.

In some embodiments, the question may be provided in a text form. In an actual scenario, the question may be provided in another mode, for example, voice or video. This is not limited in some embodiments.

(2) Non-text content: The non-text content refers to content represented by another content modality other than the text content, and the another content modality refers to a content modality which is a non-text modality, and may be, for example, an image, audio, or video.

In some embodiments, when performing responding, a response is usually made to a question of a last round. However, for the last round of question-answering process, non-text content may be provided in the round of question-answering process, or may be provided in a historical question-answering process before the round of question-answering process. That is, whether the non-text content is provided by a latest round of question-answering process is not limited. As shown in FIG. 3B, in a first round of question-answering process (that is, a round of “What plant is in the picture”), an image is uploaded, so that input content of the round may include the image. In a second round of question-answering process (that is, a round of “What color is it”), although no image is uploaded, the image uploaded in the first round of question-answering process may still be used as non-text content of the second round of question-answering process.

In some embodiments, a number of rounds of non-text content traceable in each round of question-answering process may be preset. Non-text content within a range of the number of rounds may be used as non-text content of a last round of question-answering process. For example, if the number of rounds is set to 5, the non-text content uploaded within 5 rounds of question-answering process before the last round of question-answering process remains valid for the last round of question-answering process.

In some embodiments, one question and corresponding response content obtained according to the question may be considered as one round of question-answering process.

Operation 202: Perform, when the session content further includes non-text content, multimodal intent recognition on the session content and the non-text content, to obtain a corresponding multimodal intent recognition result.

In this operation, when the session content further includes non-text content, a content relevance between text content and the non-text content in the session content is determined.

In some embodiments, although the non-text content is supported as input content, considering that non-text content uploaded by a user may not be relevant to a last round of question-answering process in an actual scenario, such non-text content does not bring a beneficial effect to a subsequent response process. On the contrary, due to a larger amount of data to be processed, a processing burden of a model may further be increased. Therefore, in some embodiments, by performing multimodal intent recognition on the session content and the non-text content, an obtained multimodal intent recognition result is configured for indicating a content relevance between the session content (for example, text content) and the non-text content. For example, the multimodal intent recognition result may indicate whether the multi-round session is relevant to the non-text content, or the multimodal intent recognition result may indicate a relevance type or level to which the multi-round session and the non-text content belong, or the multimodal intent recognition result may indicate a relevance numerical value between the multi-round session and the non-text content.

When performing multimodal intent recognition on the session content and the non-text content, the session content may refer to text content included therein, and the text content may include question text content and response text content involved in at least one round of question-answering process.

In some embodiments, the content relevance may also indicate a degree of dependence on the non-text content when responding to a question mentioned in the text content. For example, the content relevance refers to a degree of dependence of the last round of question-answering process on the non-text content in the input content. For example, an expression mode of the degree of dependence may be “dependent (or yes)” or “independent (or no)”. “Dependent” indicates that responding to the question mentioned in the text content needs to depend on the non-text content, and “independent” indicates that responding to the question mentioned in the text content does not need to depend on the non-text content. Accordingly, the content relevance is relevant or irrelevant. For another example, another expression mode of the degree of dependence may adopt a numerical value for expression, for example, a numerical range of 0 to 1. The closer to 0, the lower the degree of dependence indicated, and the lower the corresponding content relevance. The closer to 1, the higher the degree of dependence indicated, and the higher the corresponding content relevance.

In some embodiments, the content relevance may be understood as a relevance between the non-text content and at least one round of question-answering process.

In some embodiments, an expression mode of the content relevance may be a preset set of relevance types. The content relevance between the text content and the non-text content may be classified into a relevance type. For example, one relevance type may be represented by using one category text. Different relevance types may be indicated by using different category text. One category text may indicate one relevance range, and each category text may include at least one character position, and may be in a form of words, symbols, numbers, or the like.

For example, the relevance type may be defined as “yes” and “no”. “Yes” indicates that session content and non-text content are relevant, and the non-text content needs to be depended on when responding to a question. “No” indicates that session content and non-text content are irrelevant, and the non-text content does not need to be depended on when responding to a question.

For another example, the relevance types may be defined as “completely relevant”, “basically irrelevant”, and “completely irrelevant”. “Completely relevant” indicates that a content relevance between session content and non-text content is high, and a degree of dependence on the non-text content when responding to a question is high. “Basically irrelevant” indicates that the content relevance between the session content and the non-text content is low, and the non-text content may not be depended on when responding to the question. “Completely irrelevant” indicates that the content relevance between the session content and the non-text content is extremely low, and the non-text content does not completely need to be depended on when responding to a question. A reason for setting “basically irrelevant” is that in a practical process, if only two extreme types of “completely relevant (or yes)” and “completely irrelevant (or no)” are defined, classification errors easily occur for some borderline questions. By defining three types, the type of “basically irrelevant” is added. This type is configured for marking the situation of borderline questions specifically, thereby reducing classification errors, improving accuracy of the content relevance, and further improving accuracy of the response content.

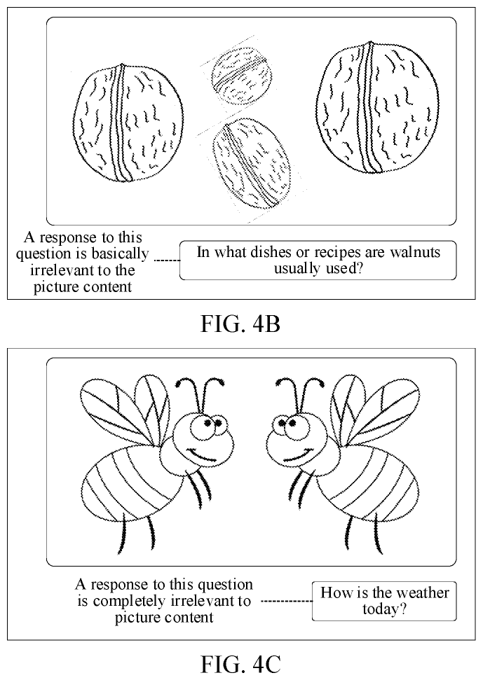

FIG. 4A to FIG. 4C are examples of different content relevances between text content and non-text content according to some embodiments. Specifically, description is made by taking the non-text content as an example of a picture. In FIG. 4A, the text content is “Describe this picture”. An intent of a current question is to describe content in the picture. Apparently, the question cannot be answered without the uploaded picture. Therefore, a response to this question is apparently completely relevant to picture content. In FIG. 4B, a uploaded picture includes a picture including walnuts, and the text content is “In what dishes or recipes are walnuts usually used?”. A common point of both is that “walnuts” are included. However, the question may be responded without content of the current picture. Therefore, although a particular association exists between the text content and the non-text content, a response to this question is apparently basically irrelevant to the picture content. In FIG. 4C, a uploaded picture includes two bees, and the text content is “How is the weather today?”. No association exists between the two. Apparently, responding to the current question completely does not need to depend on content of the current picture. Therefore, the response to the question is apparently completely irrelevant to the picture content.

In some embodiments, an expression mode of the content relevance may further adopt a numerical value for expression, for example, a numerical range of 0 to 1. The closer to 0, the lower the content relevance indicated, and the closer to 1, the higher the content relevance indicated.

In some embodiments, when determining the content relevance between text content and non-text content, the determination may be performed according to session content (for example, text content) of at least one round of question-answering process and the non-text content. That is, multimodal intent recognition may be performed by synthesizing content involved in multiple rounds of dialogue process and the non-text content, to obtain a corresponding content relevance.

Considering that in an actual scenario, a user may upload non-text content of a plurality of content modalities during a question-answering process, that is, the non-text content may include content respectively corresponding to at least one content modality. For example, the non-text content may include an image, a video, or audio.

In some embodiments, when performing determination of the content relevance, the content relevance may be separately determined for content of each content modality. The multimodal intent recognition result may include content relevances corresponding to at least one content modality, that is, the content relevance between content corresponding to each content modality of the at least one content modality and the text content. In this way, in subsequent operations, at least one target content modality whose content relevance satisfies a preset relevance condition may be determined from the at least one content modality, and a target response model matching the at least one target content modality is determined from a candidate response model set.

For example, for content of each content modality, multimodal intent recognition may be performed according to text content in session content and the content of this content modality, to determine a content relevance between the session content and the content of this content modality.

In some embodiments, when performing determination of the content relevance, content corresponding to each of the at least one content modality may further be used as a whole to determine the content relevance with the session content.

In some embodiments, when there is a plurality of pieces of non-text content, when the content relevance is determined, a sub-relevance may be separately determined for each piece of non-text content. The content relevance includes a sub-relevance corresponding to each piece of non-text content. For example, if the non-text content includes two images, sub-relevances between the two images and the text content may be determined, respectively.

Operation 203: Determine, from the candidate response model set based on the multimodal intent recognition result, a matching target response model.

In this operation, when the content relevance satisfies a preset relevance condition, a target response model matching a content modality of the non-text content is determined from the candidate response model set.

In some embodiments, the candidate response model set includes a plurality of candidate response models, and each candidate response model corresponds to an intent type. In this operation, a target response model matching an intent may be selected based on an intent recognition result.

In some embodiments, the multimodal intent recognition result indicates the content relevance between the session content and the non-text content. If the content relevance indicated by the multimodal intent recognition result satisfies the preset relevance condition, a target response model matching an intent type of the session content is determined from a candidate response model subset related to a content modality of the non-text content and included in the candidate response model set.

For example, candidate response models in the candidate response model set may be divided into different candidate response model subsets according to whether the preset relevance condition is satisfied and a content modality of the non-text content. When the preset relevance condition is satisfied, the candidate response model subset is determined based on the content modality of the non-text content. When the relevance condition is not satisfied, a corresponding candidate response model subset is a candidate response model subset related to a text modality. In the same candidate response model subset, different candidate response models may correspond to different intent types, so that response content may be generated based on a corresponding intent type.

For example, when the content relevance is “completely relevant”, a corresponding candidate response model subset is a candidate response model subset related to a content modality of the non-text content. When the content relevance is “basically irrelevant” or “completely irrelevant”, a corresponding candidate response model subset is a candidate response model subset related to a text modality.

The preset relevance condition may be set according to a requirement in an actual scenario. content of the preset relevance condition is not limited in some embodiments.

For example, when the content relevance is represented by a numerical value, the preset relevance condition may be a set relevance threshold, for example, 50% or 80%. Whether the non-text content is used as actual input content may be determined by comparing the content relevance with the preset relevance threshold. For example, when the content relevance is not less than the preset relevance threshold, it is considered that the preset relevance condition is satisfied. On the contrary, when the content relevance is less than the preset relevance threshold, it is considered that the preset relevance condition is not satisfied.

For another example, when the content relevance is represented by a category text, the preset relevance condition may be that the content relevance is a specified category text. For example, when the content relevance is completely relevant, it is considered that the preset relevance condition is satisfied. On the contrary, when the content relevance is another category text (such as basically irrelevant or completely irrelevant), it is considered that the preset relevance condition is not satisfied.

When the multimodal intent recognition result indicates that the content relevance between the session content and the non-text content is high, a user intends to acquire information in the non-text content or obtain response content based on the information of the non-text content. A model related to a content modality of the non-text content may be used to generate corresponding response content. When the content relevance is low, on the contrary, a user intent is not to acquire information in the non-text content or obtain response content based on the information of the non-text content. The response content may be obtained based on text content only, and a model related to a text modality may be used to generate corresponding response content.

For example, when the non-text content is an image, if the multimodal intent recognition result indicates that the session content is completely relevant to the image, an image captioning model is determined to be invoked to generate response content. If the multimodal intent recognition result indicates that the session content is basically irrelevant or completely irrelevant to the image, a text-related model may be invoked to generate response content.

In some embodiments, the multimodal intent recognition result indicates the content relevance between the session content and the non-text content, and the content relevance may indicate a degree of dependence on the non-text content when responding to a question in response text content. The higher the degree of dependence, the lower a probability of responding to the question without the non-text content. Therefore, actual input content inputted into a response model may be determined accordingly, and a matching target response model may be selected based on a content modality involved in the actual input content.

In some embodiments, when a degree of dependence on non-text content when responding to a question in text content is higher, the non-text content needs to be used as actual input content. For example, text content of a last round and the non-text content are used as the actual input content, or the text content of the last round, the non-text content, and a historical question-answering record are used as the actual input content. On the contrary, when the degree of dependence on the non-text content when responding to the question in the text content is lower, a probability of responding to the question without the non-text content is higher. Therefore, to some extent, the non-text content may not be used as the actual input content. For example, only the text content of the last round is used as the actual input content, or the text content of the last round and the historical question-answering record are used as the actual input content.

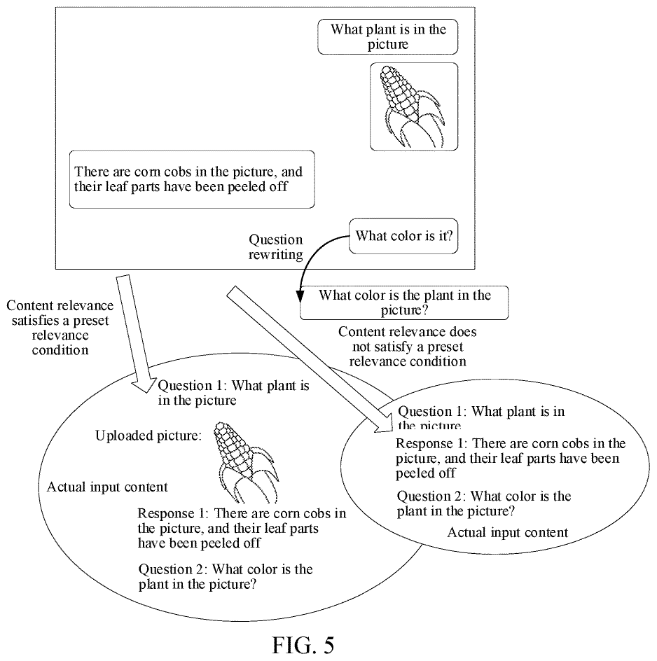

FIG. 5 is a logic schematic diagram of determining actual input content according to some embodiments. Whether the content relevance satisfies the preset relevance condition may be determined. If the content relevance does not satisfy the preset relevance condition, it indicates that a response to a current question does not need to depend on non-text content, and the non-text content does not need to be used as input content. An intent type of the text content may be recognized, and a target response model matching the intent type of the text content may be determined from a candidate response model subset related to a text modality and included in the candidate response model set. In some embodiments, a question of a last round of question-answering process may be rewritten based on context information in the session content, an intent type of rewritten text content may be recognized, and a target response model matching the intent type may be determined from a candidate response model subset related to a text modality in the candidate response model set. That is, the rewritten text content is used as the actual input content. In this way, the non-text content does not need to be processed, so as to reduce a processing burden of a model. However, if the content relevance satisfies the preset relevance condition, it indicates that the response to the current question needs to depend on the non-text content, and the non-text content needs to be used as the input content. Therefore, the non-text content and the rewritten text content may be used as the actual input content. Certainly, in addition to the content, a historical question-answering record may also be used as the actual input content. This is not limited in some embodiments.

In this implementation, the candidate response model set includes a plurality of candidate response models. Each candidate response model may process content of at least one content modality, and may output response content of a last round of question-answering process based on the content of the at least one content modality. Content modalities that different candidate response models are capable of processing may be the same or different. In some examples, a candidate response model may be referred to as a plug-in.

In practical applications, actual input content may include at least one content modality, such as one or more of a text modality, an image modality, a video modality, and an audio modality. In order to smoothly process the actual input content, a selected target response model needs to understand content of various modalities included in the actual input content. Therefore, a matching target response model may be selected from the candidate response model set based on the content modality included in the actual input content. For example, candidate response model A may generate corresponding response content based on the text content, candidate response model B may generate corresponding response content based on the text content and image content, and candidate response model C may generate corresponding response content based on the image content. When the actual input content includes only text content, the candidate response model A may be selected as the target response model.

In some embodiments, the candidate response models in the candidate response model set may be divided into different candidate response model subsets according to different content modalities that may be processed. Candidate response models in the same candidate response model subset are capable of processing the same content modality. At least one content modality in content modalities corresponding to any two candidate response model subsets is different. In the same candidate response model subset, different candidate response models may correspond to different intent types, so that response content may be generated based on a corresponding intent type. For example, for a candidate response model subset processing text content, the subset may include a weather plug-in, a calendar plug-in, a map plug-in, and a text-to-image plug-in. The weather plug-in is configured to generate weather-related response content when current text content is recognized to be configured for inquiring about weather-related content. The calendar plug-in is configured to generate calendar-related response content when current text content is recognized to be configured for inquiring about calendar-related content, and so on.

Based on at least one content modality included in the actual input content, a target response model subset matching the at least one content modality may be determined from a plurality of candidate response model subsets included in the candidate response model set. In addition, an intent type of the actual input content may be recognized. For example, text intent recognition may be performed based on the text content in the actual input content, to obtain the corresponding text intent recognition result. Further, the target response model matching the intent type of the actual input content may be determined from the target response model subset. For example, if the intent recognition result indicates video description, a target response model capable of describing content of the video may be selected. In some embodiments, if the intent recognition result indicates weather description, a weather-related target response model may be selected, such as the foregoing weather plug-in.

By this implementation, a matching target response model may be selected by synthesizing two dimensions of a content modality and an intent type, so that a selected target response model is capable of processing current input content and matches the content intent, thereby generating more accurate response content, so as to improve accuracy of the response content, and thereby improving the user's experience.

In some embodiments, when the non-text content includes content respectively corresponding to at least one content modality, the multimodal intent recognition result may include a content relevance corresponding to each of the at least one content modality.

In some embodiments, when determining the target response model, based on the multimodal intent recognition result, a target content modality whose content relevance satisfies the preset relevance condition may be determined from the at least one content modality. Further, the matching target response model may be determined from the candidate response model subset related to the target content modality.

In some embodiments, to determine the actual input content, the actual input content may be obtained based on content of a content modality whose content relevance satisfies the preset relevance condition, and the text content. That is, when non-text content of a plurality of content modalities exists, a content modality satisfying the preset relevance condition may be selected therefrom, so as to use non-text content corresponding to the content modality as the actual input content.

By this implementation, non-text content having a high content relevance to text content in a current round of question-answering process may be selected from the non-text content of the plurality of content modalities, so as to use the non-text content together as the actual input content, helping refer to the non-text content when responding to a question in the text content, and improving accuracy of response content.

When the non-text content includes a plurality of pieces of content, after content relevances corresponding to the plurality of pieces of content are determined, content satisfying the preset relevance condition may be selected therefrom, so as to use the content as the actual input content.

Operation 204: Obtain response content to a question mentioned in a last round of question-answering process using the target response model based on the session content and an intent type corresponding to the target response model.

In this operation, the response content to the question of the last round of question-answering process is obtained using the target response model based on the session content.

In some embodiments, each candidate response model in the candidate response model set is a trained neural network model, and is capable of generating response content meeting requirements based on its corresponding intent type. Further, after the target response model is selected, the actual input content may be used as input, and the target response model is invoked to perform forward inference, so as to obtain response content outputted by the target response model. For example, the candidate response model may be a natural language model, and the actual input content may be used as a prompt text to generate subsequent content, and the subsequent content is used as the response content. Certainly, the candidate response model may be another type of model. This is not limited in some embodiments.

Hereinafter, a process of performing multimodal intent recognition on the session content and the non-text content to obtain a multimodal intent recognition result is described. In some embodiments, the content relevance may be recognized through the following implementations.

In some embodiments, a multimodal intent recognition model may be obtained through a model training method. Further, session content and non-text content may be used as inputs to the model, and forward inference is performed by a trained multimodal intent recognition model, so as to obtain a multimodal intent recognition result outputted by the multimodal intent recognition model.

For example, when a category text is used as a classification of the content relevance, the multimodal intent recognition model may be implemented by the multimodal intent recognition model obtained based on a prompt learning method. The multimodal intent recognition model obtained based on the prompt learning method is a generative natural language model, configured for predicting subsequent content of prompt information based on an input prompt instruction. Therefore, the session content and the non-text content may be used as prompt information to generate the category text.

The text content and the non-text content in the session content may be organized into a prompt instruction according to a preset prompt content template, and the prompt instruction is inputted into the multimodal intent recognition model, to obtain the content relevance outputted by the multimodal intent recognition model. For example, before the prompt information is inputted into the multimodal intent recognition model, corresponding target prompt content needs to be generated according to the preset prompt content template and based on the session content and the non-text content. The prompt content template is a template type that the multimodal intent recognition model is capable of recognizing, and is configured to help the multimodal intent recognition model understand semantic information of each part of the content.

In some embodiments, positions of the content and a sequence therebetween are preset in the prompt content template. Therefore, the corresponding target prompt content may be generated according to the prompt content template. For example, when generating the target prompt content, an attribute label and a round label may be added to the text content in the session content according to a chronological order of at least one round of question-answering process. The attribute label indicates whether the corresponding text content is question content or response content, to assist the model in distinguishing an attribute of the text content. The round label indicates a question-answering round number corresponding to the corresponding content, to assist the model in distinguishing the round number to which the content belongs. In addition, for the non-text content, a corresponding modality label may further be added to the non-text content. The modality label indicates a content modality corresponding to the non-text content, to assist the model in distinguishing the content modality to which the non-text content belongs. Further, labeled content may be combined according to a preset content sequence in the prompt content template, to obtain target prompt content as a prompt instruction.

In some embodiments, by adding attribute labels, round labels, modality labels, and the like to the prompt content template, the model may be helped to more accurately distinguish the content item, thereby enabling the model to more accurately understand the content, so as to obtain more accurate content relevance. The process of adding labels may be considered as a process of filling content into a target prompt template. That is, various labels are already included in the target prompt template, and the content may be filled into a corresponding position based on the label corresponding to each piece of content.

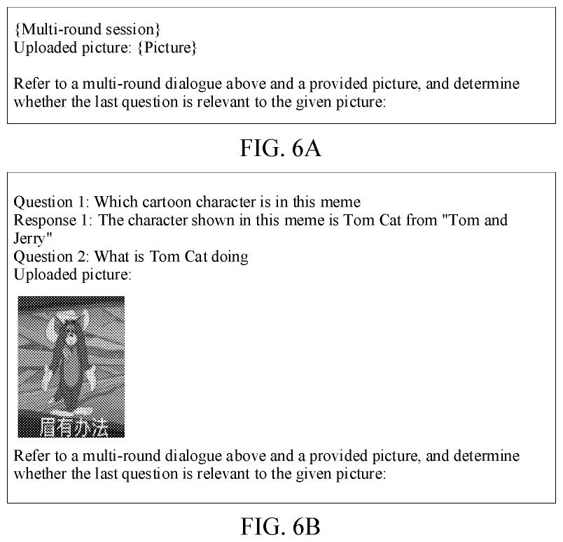

FIG. 6A is an example of a target prompt template according to some embodiments. Taking non-text content as an example of an image, the target prompt template includes “multi-round session”, “uploaded picture”, and prompt content “Refer to the multi-round dialogue above and the provided picture, and determine whether the last question is relevant to the given picture:”. The “multi-round session” part is configured for filling text content involved in a multi-round question-answering process. The “uploaded picture” part is configured for filling an image. In the “multi-round session”, “Question 1” represents a first question in the multi-round dialogue, “Response 1” represents response content to the first question in the multi-round dialogue, “Question 2” represents a second question in the multi-round dialogue, and so on, until a question of a last round. In the “uploaded picture”, picture content to be questioned is inputted.

Exemplarily, FIG. 6B shows an example of target prompt content. As shown in FIG. 6B, “Question 1” indicates that content belongs to text content including a question, and belongs to a first round of question-answering process. “Response 1” indicates that content belongs to response content, and belongs to the first round of question-answering process, and so on for the rest. “Uploaded picture” indicates that corresponding content is of an image modality. Certainly, when the non-text content is of another modality, a corresponding label may be used for denotation, and content of the labels is not limited in some embodiments.

After the target prompt content is obtained, the target prompt content may be used as a prompt instruction, and inputted into a trained multimodal intent recognition model, to obtain a multimodal intent recognition result outputted by the multimodal intent recognition model.

By this implementation, in some embodiments, the content relevance is generated by the trained multimodal intent recognition model in a content generation mode, helping improve efficiency of multimodal intent recognition.

In some embodiments, feature extraction may be performed on text content in a historical question-answering record (which may include question content and response content) and text content of a last round of question-answering process, and feature extraction may be performed on the non-text content. Further, the multimodal intent recognition result may be determined based on a similarity between features. In the two feature extraction processes, the text content and the non-text content may be mapped to the same feature space for comparison, thereby making the two more similar, and indicating that the content relevance between the two is higher.

In some embodiments, word segmentation may further be performed on text content in a historical question-answering record (which may include question text content and response text content). Further, feature matching may be performed between segmented words and the non-text content, and the multimodal intent recognition result may be obtained by synthesizing matching degrees between the segmented words and the non-text content. The higher the matching degree between the segmented words in the text content and the non-text content, and the more segmented words having a high matching degree, the higher the content relevance.

In practical applications, considering that the higher the degree of influence of text content of a last round of question-answering process on response content, different weights may be set for text content of different question-answering processes. For example, the greater the weight of segmented words of text content of the last round of question-answering process when calculating the content relevance, and the smaller the weight of segmented words of text content of a question-answering process that is earlier in time when calculating the content relevance.

In some embodiments, when a multimodal intent recognition model is used to determine the content relevance, the multimodal intent recognition model may adopt an artificial neural network model based on deep learning. The model may be any possible model, for example, a generative pre-trained (GPT) series model, Transformer, an encoder-decoder architecture model, a recurrent neural network (RNN), long short-term memory (LSTM), or a variant model of the foregoing models.

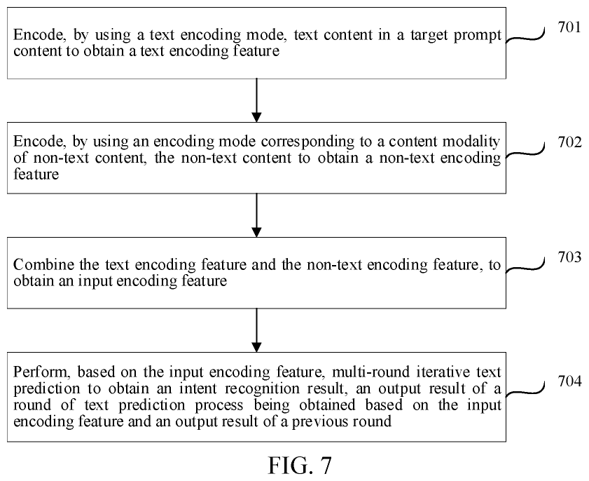

FIG. 7 is a schematic flowchart of determining, by using a multimodal intent recognition model, a multimodal intent recognition result according to some embodiments. In this process, the following operations may be performed by using a trained multimodal intent recognition model to obtain the multimodal intent recognition result.

Operation 701: encode, by using a text encoding mode, text content in a target prompt content to obtain a text encoding feature.

In some embodiments, each piece of text content in the target prompt content may be encoded, to obtain a text encoding feature of each piece of text content, and each obtained text encoding feature may be concatenated to obtain a final text encoding feature. In some embodiments, each piece of text content in the target prompt content may be concatenated in a format, and then overall text encoding may be performed, to obtain the text encoding feature. The text encoding feature may be referred to as a text representation, a text embedding, or a text representation vector, and the like.

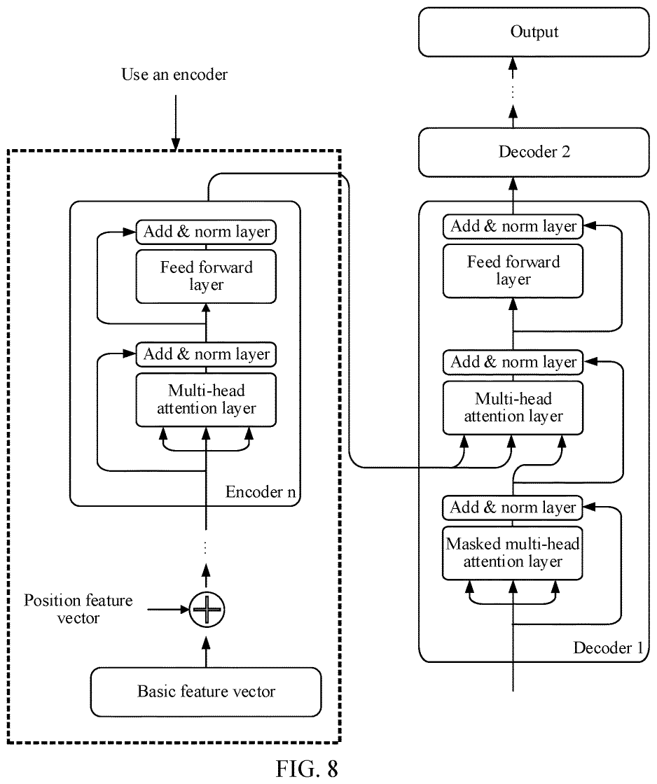

The text encoding may be implemented by a text encoder. The text encoder may adopt any possible encoder structure, such as an encoder part of a GPT model, Transformer, encoder-decoder, RNN, or LSTM. Taking Transformer as an example, Transformer is capable of capturing long-distance dependency relationships of sequence data more efficiently. FIG. 8 is a schematic structural diagram of a Transformer model. Transformer includes a plurality of encoders and decoders, and the plurality of encoders are of a cascaded structure. In some embodiments, one or more layers of encoder structures may be used, that is, the encoder structure shown in a dashed box in FIG. 8. feature extraction is performed on text units (such as segmented words or words) in the text content, and extracted features are superimposed with corresponding position information. After superimposed content feature vector is inputted into the encoder, the vector is processed by an attention layer, then processed by an additive normalization (add & norm) layer and inputted into a feed forward layer, and then processed by another add & norm layer, to obtain a final text encoding feature.

The attention layer may be a multi-head attention layer, a self-attention layer, and the like. The feed forward layer may be a position-wise feed-forward neural network, a multilayer perceptron (MLP), and the like. A plurality of attention layers and feed forward layers are stacked together through residual connections and layer normalization. The self-attention layer captures context-related information in a sequence through a self-attention mechanism. Calculation of the self-attention involves three weight matrices (a query matrix Q, a key matrix K, and a value matrix V), and the final attention weight is calculated through dot product, scaling, Softmax activation, and weighted summation. Layer normalization is configured for accelerating model convergence. Layer normalization is used after output of each layer to perform normalization thereon, so as to alleviate gradient vanishing and explosion problems in the network.

Operation 702: Encode, by using an encoding mode corresponding to a content modality of the non-text content, the non-text content to obtain a non-text encoding feature.

For example, when the non-text content is video, a corresponding video encoding feature is obtained by using a video feature encoding mode. When the non-text content is an image, a corresponding image encoding feature is obtained by using an image feature encoding mode. Hereinafter, taking the non-text content as an example of an image, the encoding process of the non-text content is described.

In some embodiments, image encoding may be implemented by vision transformer (VIT), or an encoder part of another possible model may be used. This is not limited in some embodiments.

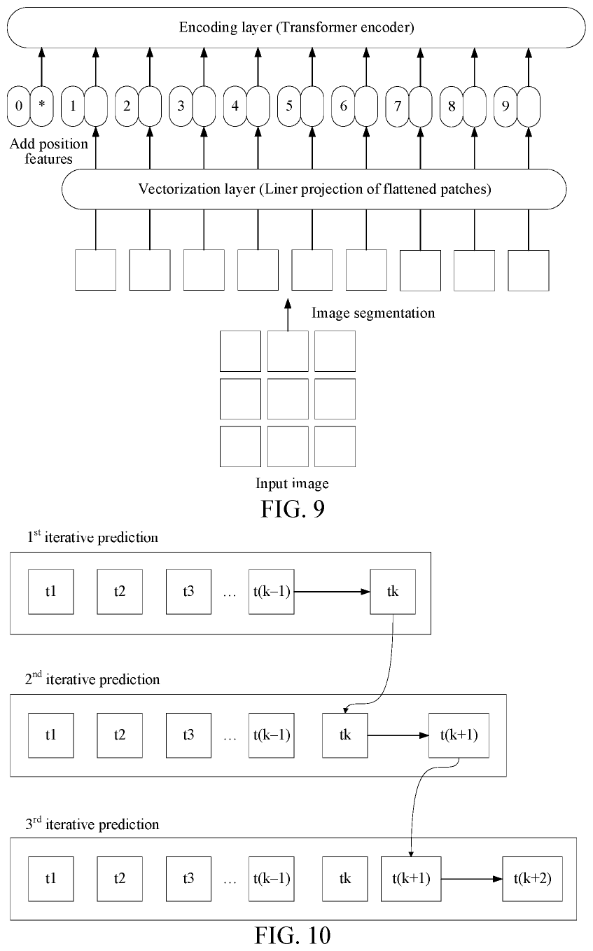

FIG. 9 is a schematic flowchart of an image encoding process according to some embodiments. After an image is inputted, image segmentation is first performed on the image, to obtain a plurality of image blocks, and the image blocks are inputted into a vectorization layer. The vectorization layer is configured to perform image encoding on the plurality of image blocks, respectively, to obtain corresponding image block encoding features. As shown in FIG. 9, the vectorization layer may be a linear projection of flattened patches, so as to convert the image from a three-dimensional matrix to a two-dimensional matrix. Assuming that a dimension of an input image is (224, 224, 3), one picture is divided into a size of 16×16, and 196 patches may be obtained after division. A size of each patch is 16×16. Moreover, corresponding position encoding features are obtained based on positions of the plurality of image blocks in the image. Further, obtained image block encoding features may be subjected to serialized encoding based on obtained position encoding features to obtain a corresponding image encoding feature. 1 to 9 as shown in FIG. 9, for each image block, a position feature may be added to a corresponding image block feature based on a position of the image block in the input image. Finally, image block features with added position features are inputted into an encoding layer for serialized encoding. In addition, for convenience of distinction, in FIG. 9, a category token for classification is further added before the sequence, that is, “0*” shown in FIG. 9. The category token is a trainable parameter. The encoding layer may use, for example, an encoder of Transformer shown in FIG. 8, or another possible encoder structure may also be used. This is not limited in some embodiments.

By this implementation, the image may be converted from three-dimensional features to two-dimensional features, so as to be combined with text features to perform subsequent processes.

Operation 703: Combine the text encoding feature and the non-text encoding feature, to obtain an input encoding feature.

For example, the text encoding feature and the non-text encoding feature may be concatenated to obtain the input encoding feature.

Operation 704: Perform, based on the input encoding feature, multi-round iterative text prediction to obtain an intent recognition result, an output result of a round of text prediction process being obtained based on the input encoding feature and an output result of a previous round.

In some embodiments, the input encoding feature may be understood as a feature sequence including a token sequence. The input encoding feature may be used as prompt information, to generate a subsequent text sequence. The text sequence is a category text configured for indicating the content relevance. The iterative text prediction process is a process of decoding the input encoding feature. Therefore, it may be implemented by a decoder, for example, a decoder part of Transformer.

In some embodiments, multiple text predictions may be performed in an autoregressive mode. That is, during one text prediction, an output result of a current text prediction process is obtained based on the input encoding feature and an output result of a previous text prediction process. During an initial text prediction, prediction is directly performed based on the input encoding feature. After one text prediction is completed, the prediction result is concatenated after the input feature used in the current time, and next text prediction is performed until an iteration ending condition is satisfied.

FIG. 10 is an exemplary diagram of iterative text prediction. Herein, the input encoding feature may be represented as a token sequence t₁ . . . tₖ₋₁, which may correspond to the token sequence after encoding in the example shown in FIG. 6B. A 1ₛₜ prediction is performed by the multimodal intent recognition model, that is, a next token tₖ is generated based on t₁ . . . tₖ₋₁ shown in FIG. 6B. By adding the next token to a generated token sequence, a new token sequence t₁ . . . tₖ may be obtained. Then, the multimodal intent recognition model performs a 2^{nd} prediction based on the generated token sequence t₁ . . . tₖ, to generate a next token tₖ₊₁. By adding the next token to the generated token sequence, a new token sequence t₁ . . . tₖ₊₂ may be obtained. By analogy, the process continues until an iteration ending condition is satisfied.

In some embodiments, the iterative prediction ending condition in some embodiments includes at least one of the following conditions:
(1) When a length of a predicted token sequence reaches its upper limit value, iterative prediction is stopped.
(2) After a terminator, i.e. a character indicating sequence ending described above, is obtained through decoding or prediction, the iterative prediction ends. The terminator indicates the end of a sequence.

In some embodiments, the intent recognition result may be, for example, “completely relevant”, “basically irrelevant”, or “completely irrelevant”, thereby indicating whether a response of a current round needs to depend on non-text content.

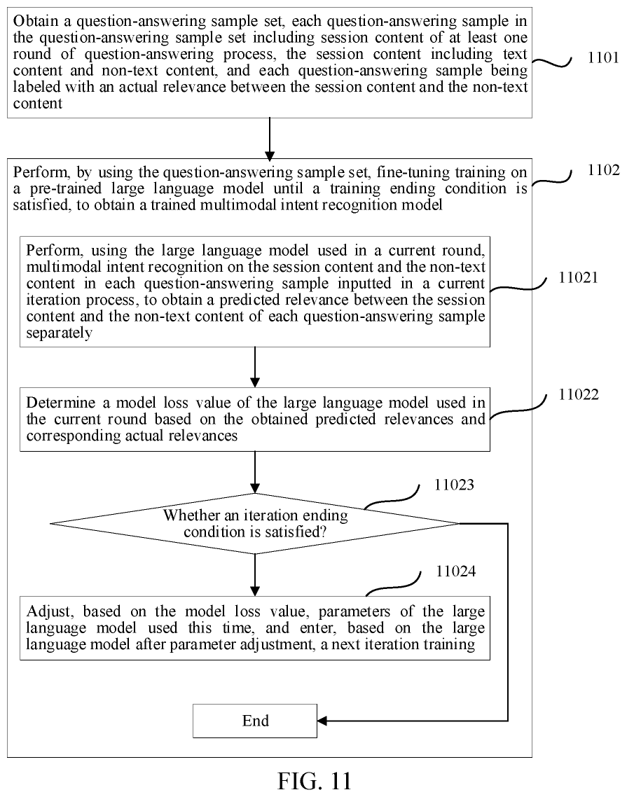

In some embodiments, before the above process is performed based on the multimodal intent recognition model, a multimodal intent recognition model further needs to be obtained through a training method. Hereinafter, a training process of the multimodal intent recognition model is described. FIG. 11 is a schematic flowchart of a training method according to some embodiments.

Operation 1101: Obtain a question-answering sample set, each question-answering sample in the question-answering sample set including session content of at least one round of question-answering process, the session content including text content and non-text content, and each question-answering sample being labeled with an actual relevance between the session content and the non-text content.

In some embodiments, the multimodal intent recognition model in some embodiments may be a model obtained by performing SFT based on a large language model pre-trained on a large-scale corpus by using small-scale finely-labeled data, to obtain a model for a task, that is, the multimodal intent recognition model in some embodiments.

Before performing SFT, small-scale finely-labeled training data, that is, a question-answering sample set, needs to be prepared in advance. Each question-answering sample in the question-answering sample set may include session content of at least one round of question-answering process. The session content includes text content and non-text content. The content in the question-answering process may be question-answering records of the question-answering process collected from an actual application, and each question-answering sample is labeled with an actual relevance between the session content and the non-text content.

In an implementation, the question-answering sample in the question-answering sample set may be used to obtain corresponding target prompt content by using a target prompt template. Therefore, an actual relevance of a text sample may be considered as a category text generated by using the target prompt content as prompt information. That is, each question-answering sample may be a pair of (multi-round session, relevance label). The multi-round session represents content involved in the question-answering process. The relevance label indicates the actual relevance, and may be understood as an expectation of a multimodal intent recognition result.

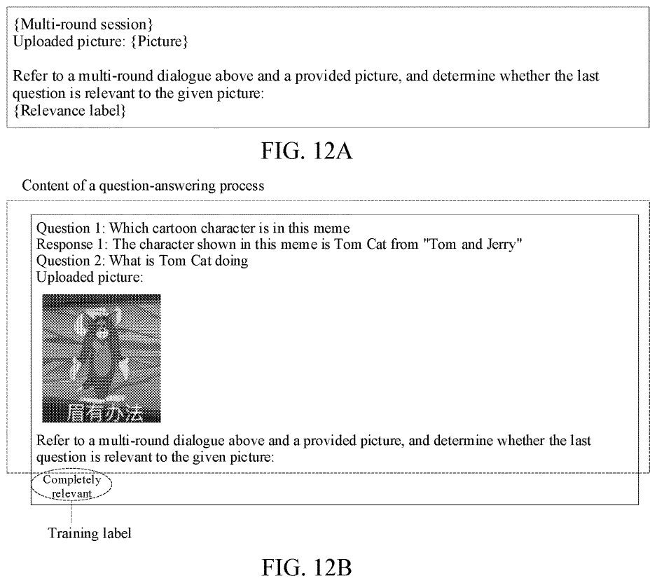

FIG. 12A is an example of a Prompt template in a training stage according to some embodiments. The “multi-round session” and a picture in “uploaded picture” are content in a question-answering process, and are used as inputs of a model during training. The “relevance label” is used as an output of the model. For example, the relevance label may include two types of “yes” and “no”, or the relevance label may include three categories of “completely relevant”, “basically irrelevant”, and “completely irrelevant”. This is not limited in some embodiments.

Exemplarily, as shown in FIG. 12B, content in the question-answering process is concatenated to obtain a question-answering sample, to perform SFT on a large language model. The content of the question-answering process in FIG. 12B is the input of the model. “Question 1” indicates that content belongs to text content including a question, and belongs to a first round of question-answering process. “Response 1” indicates that content belongs to response content, and belongs to the first round of question-answering process, and so on for the rest. “Uploaded picture” indicates that corresponding content is of an image modality. The relevance label is an output of the model.

Operation 1102: Perform, by using the question-answering sample set, fine-tuning training on a pre-trained large language model until a training ending condition is satisfied, to obtain a trained multimodal intent recognition model.

For example, the fine-tuning training is an iterative training process, and model parameters are continuously optimized, so as to enable the model to meet accuracy requirements. When a current iteration round is a first iteration, the model used in the current iteration round is an initial model, that is, the pre-trained large language model. When the current iteration round is not a first iteration, the model used in the current iteration round is a model after parameter adjustment of a previous iteration. During each iteration of training, some or all question-answering samples may be extracted from the question-answering sample set and inputted into the model used in the current iteration round. For example, a random selection mode may be used, or batch division may be performed in advance for the question-answering sample set, and a batch of question-answering samples is inputted each time. Then, training of the current time is performed based on these input question-answering samples. That is, the model used in the current round may be used to perform model forward inference on each question-answering sample.

For example, in some embodiments, a model structure used may be any model structure capable of implementing serialized processing, such as a transformer model, an RNN model, an encoder-decoder architecture model, or a GPT series model, so as to fine-tune the model structure based on such a pre-trained model to adapt to the foregoing multimodal intent recognition task.

In some embodiments, a prompt learning method is used to perform model training. A main purpose of prompt learning is to input prompt content (or referred to as a prompt instruction) to generate subsequent or remaining text. The prompt content in some embodiments is the foregoing content except the relevance label.

Since the iteration processes are similar, the following describes one iteration process as an example. During each iteration of the fine-tuning training process, the following operations are performed:

Operation 11021: Perform, using the large language model used in the current round, multimodal intent recognition on the session content and the non-text content in each question-answering sample inputted in a current iteration process, to obtain a predicted relevance between the session content and the non-text content of each question-answering sample separately.

During training, an autoregressive language model training mode is used, and an objective is to predict a next token through a current token and tokens before the current token. Since each question-answering sample includes a relevance label, when performing prediction of the predicted relevance, the model needs to be enabled to perceive only content in the question-answering sample other than the relevance label and content already predicted, and content not yet predicted in the relevance label needs to be masked during calculation.

A process of obtaining the predicted relevance is a process of decoding input content. Therefore, it may be implemented by using a decoder, for example, a decoder module of a model such as GPT or Transformer. Taking Transformer as an example, referring to FIG. 8, the decoder includes a plurality of cascaded decoding blocks with a mask mechanism stacked and connected in series. A plurality of Transformer decoder blocks are stacked to construct a deeper-level decoder, so as to improve performance and generalization capability of the model. Referring to FIG. 8, each decoding block includes the following parts:
(1) A masked multi-head self-attention layer: This part performs multi-head self-attention calculation on an input, to capture context-related information in a sequence. Self-attention calculation involves three weight matrices (a query matrix Q, a key matrix K, and a value matrix V), and a final attention weight is calculated through dot product, scaling, Softmax activation, and weighted summation. The mask mechanism is configured for avoiding using future information in the self-attention mechanism. That is, in the self-attention mechanism, a Mask is used to mask information after a current token, so as to ensure that prediction is performed based only on previous token information.
(2) A feedforward neural network layer: This part performs fully connected layer calculation on a representation of each position, to enhance feature expression capability of the position.
(3) A residual connection layer and layer normalization: A residual connection is performed between outputs of the foregoing two parts and an input sequence, and layer normalization is performed on a result after the residual connection. Layer normalization is used after output of each layer to perform normalization on the output, so as to alleviate gradient vanishing/explosion problems in the network, accelerate model training, and improve model performance.

In an example, parameters of a Transformer decoder may be set as follows:

| Parameter | |
|---|---|
| scale | Parameter setting |
| 13 Billion | Number of Layers (NUM_LAYERS) = 40 |
| (B) | Hidden layer dimension (HIDDEN_SIZE) = 5120 |
| | Number of attention heads (NUM_ATTN_HEADS) = 40 |
| | Hidden layer dimension of feedforward network |
| | (FFN_HIDDEN_SIZE) = 13824 |
| | Attention head dimension (ATTN_HEAD_SIZE) = 128 |

The number of layers being 40 represents that the quantity of data processing layers of the decoder is 40. The hidden layer dimension is 5120, and so on.

The predicted relevance and the foregoing content relevance are the same concept, and are merely used herein to distinguish a training stage and an application stage. The process of obtaining the predicted relevance through model forward inference is the same as the process of obtaining the content relevance described above. Therefore, reference may be made to the foregoing description.

Operation 11022: Determine a model loss value of the large language model used in the current round based on the obtained predicted relevances and corresponding actual relevances.

In some embodiments, when the relevance label is a category text, one category text indicates a relevance range. For example, the category text “completely relevant” indicates a range of a higher relevance, the category text “basically irrelevant” indicates a range of a relevance lower than “completely relevant”, and the category text “completely irrelevant” indicates a range of a relevance lower than “basically irrelevant”. Each category text may include at least one character position. The predicted relevance includes a probability value set corresponding to each of the at least one character position. Each probability value set includes probability values of a corresponding character position for each candidate character in a candidate character set.

Then, when calculating the model loss value, the calculation may be performed based on the predicted relevance corresponding to each question-answering sample. For example, for one predicted relevance, a sub-loss value corresponding to the predicted relevance may be determined based on a probability value corresponding to a true character for each obtained probability value set. The true character is a character at a corresponding character position in the relevance label. Further, the model loss value may be determined based on each sub-loss value corresponding to each predicted relevance.

For example, a loss function in the SFT stage is consistent with a pre-training stage. For example, a language model may be used to minimize a maximum likelihood function. A possible expression form is as follows:

$${L}_{1} ( U ) = {\sum }_{i} log P ( {u}_{i} \vert {u}_{i - k} , … , {u}_{i - 1} : θ ) ,$$

where U represents a training data set, P indicates a probability of predicting an i^{th} token by using first k tokens, and k indicates a window size. Then, an objective of some embodiments is to maximize a product of conditional probabilities.

In some embodiments, the model loss value may be calculated by using any other possible loss function, for example, a cross entropy loss function, a mean squared error (MSE) loss function, a squared absolute error loss function, or a likelihood loss (LHL) function. Certainly, another possible loss function may be used. This is not limited in some embodiments.

Operation 11023: Determine whether the large language model used in the current round reaches an iteration ending condition.

In some embodiments, the iteration ending condition may include at least one of the following conditions:
(1) A number of iterations reaches a set number threshold.
(2) The model loss value is less than a set loss threshold, or a conditional probability is a maximum value continuously for multiple times, and the like.

Operation 11024: Adjust, if the determination in operation 11023 is negative, based on the model loss value, parameters of the large language model used this time, and enter, based on the large language model after parameter adjustment, a next iteration of training.

In some embodiments, when the number of iterations does not exceed a preset number threshold, and the model loss value is not less than the set loss threshold, the determination in operation 11023 is negative. That is, the current model is considered not to satisfy the iteration ending condition. Then, model parameters need to be adjusted to continue training. After the parameter adjustment, a next iteration of training is entered, that is, the process proceeds to operation 11021.

In some embodiments, when the model still does not satisfy a convergence condition, model weight parameters may be updated by using an optimization algorithm such as a gradient descent method or a stochastic gradient descent algorithm, so as to minimize the foregoing objective function. Training may be continued by using updated model weight parameters, so as to enable the model to better predict a next token.

When the number of iterations has exceeded the preset number threshold, or the model loss value is less than the set loss threshold, the determination in operation 11023 is affirmative. That is, the current model is considered to have satisfied the convergence condition, model training ends, and a trained multimodal model is obtained.

The foregoing model adjustment mode in some embodiments is merely a adjustment method for an autoregressive pre-trained model. Another possible fine-tuning method for a large model may be used, for example, p-tuning or LORA. In practical applications, an appropriate fine-tuning method may be used according to an actual scenario, a model scale, a learning capability, and other factors.

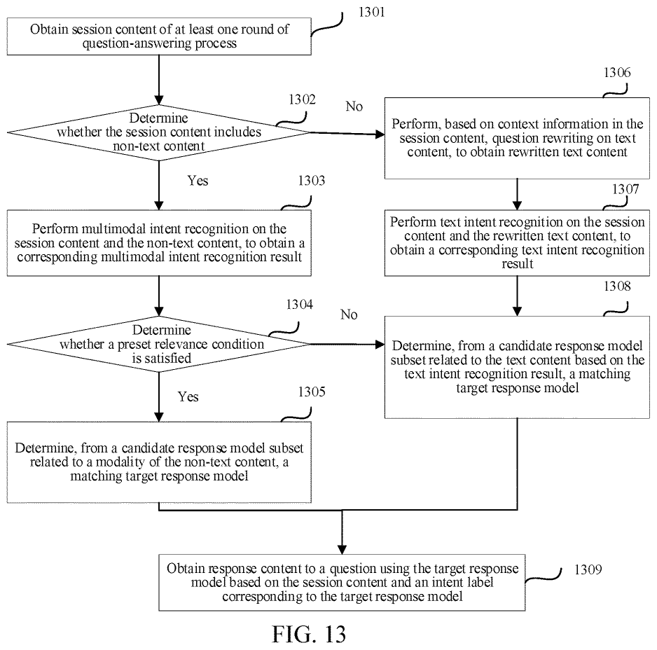

In some embodiments, FIG. 13 is a schematic flowchart of another question-answering method based on a large model according to some embodiments.

Operation 1301: Obtain session content of at least one round of question-answering process.

The session content may include content inputted in a question-answering process, and the session content at least includes text content recording a question of a last round of question-answering process. When the last round of question-answering process is a first round of question-answering process, the session content includes only input content of the last round of question-answering process. When the last round of question-answering process is not the first round of question-answering process, the session content may include text content recording a question inputted in the last round of question-answering process, and input content and response content involved in a historical question-answering record.

Operation 1302: Determine whether the session content includes non-text content.

In some embodiments, in addition to text content, the session content may further include non-text content, that is, content expressed by another modality other than a non-text modality, for example, an image, a video, or audio. Therefore, it is necessary to determine whether the session content includes the non-text content. For example, after the session content is obtained, whether the session content includes an image may be determined.

Operation 1303: Perform, if the determination result in operation 1302 is affirmative, multimodal intent recognition on the session content and the non-text content, to obtain a corresponding multimodal intent recognition result.

For example, the multimodal intent recognition model obtained through training by using the foregoing training method may be invoked to obtain the corresponding multimodal intent recognition result. The multimodal intent recognition result is configured for indicating a content relevance between the session content and the non-text content. That is, the multimodal intent recognition result may be configured for indicating a relevance between a multi-round session and the non-text content, for example, whether relevant, or which relevance type it belongs to. In other words, the multimodal intent recognition result may be understood to indicate a degree of dependence of a response to the question of the last round of question-answering process on the non-text content. For example, a high relevance indicates that the response to the question has a high degree of dependence on the non-text content, while a low relevance indicates that the response to the question has a low degree of dependence on the non-text content.

Operation 1304: Determine, based on the multimodal intent recognition result, whether a preset relevance condition is satisfied. For example, determining whether the relevance degree is greater than a preset relevance threshold, or determining whether the multi-round session is relevant to the non-text content, or determining whether the multimodal intent recognition result belongs to a specified relevance type.

Operation 1305: Determine, if the determination result in operation 1304 is affirmative, that is, the relevance degree is greater than the preset relevance threshold, or the multi-round session is relevant to the non-text content, or the multimodal intent recognition result indicates that the relevance degree belongs to a “completely relevant” type, a matching target response model from a candidate response model subset related to a content modality of the non-text content.

Operation 1306: Perform, based on context information in the session content, question rewriting on text content, to obtain rewritten text content. If the determination result in operation 1302 is negative, operation 1306 may be directly executed.

In practical applications, a question expressed by text content inputted by a user is not comprehensive, or the question may have multiple ambiguities, and needs to be combined with a context to express the actual meaning of the question. Then, after the input content is obtained, question rewriting may be performed on the text content, so that the rewritten text content better conforms to reading logic or expresses a definite meaning. The question rewriting function may be referred to as a multi-round rewriting function, and refers to a process of rewriting a question of a current session by combining content of a multi-round dialogue. The process may be implemented by a multi-round rewriting (QueryRewrite) component. The multi-round rewriting component is a component for processing a multi-round dialogue and query rewriting, and may be configured to understand and optimize an interaction process between a user and a robot, and perform anaphora resolution and ellipsis completion.

For example, question rewriting may be performed on the text content based on the historical question-answering record, to obtain the rewritten text content. Referring to FIG. 5, the text content inputted by the user is “What color is it”. Viewed from the text content alone, the sentence lacks a subject, and therefore cannot completely express content of the question. However, combined with the context, it can be seen that the user's intent is to inquire about the color of a plant in the picture. Then, question rewriting may be performed on the current text content. As shown in FIG. 5, it may be rewritten as “What color is the plant in the picture”, thereby clearly expressing an object targeted by the question, facilitating understanding of the question by the model, and helping improve accuracy of response content.

Operation 1307: Perform text intent recognition on the session content and the rewritten text content, to obtain a corresponding text intent recognition result.

That is, a text intent recognition method is used for text content involved in the session content, to obtain the text intent recognition result. For example, the intent of the question in the last round of question-answering process is recognized to be obtaining weather, calendar, map, or other information, or generating an image based on text, so as to invoke a corresponding response model to generate response content.

Operation 1308: Determine, if the determination result in operation 1304 is negative, from a candidate response model subset related to the text content based on the text intent recognition result, a matching target response model.

For example, when the relevance degree is not greater than the preset relevance threshold, or the multi-round session is not relevant to the non-text content, or the multimodal intent recognition result indicates that the relevance degree belongs to a “basically irrelevant” or “completely irrelevant” type, it is determined that the preset relevance condition is not satisfied. Then, a finally used target response model may be selected based on the text intent recognition result.

Operation 1309: Obtain response content to the question using the target response model based on the session content and an intent label corresponding to the target response model.

Some operations in the method shown in FIG. 13 are similar to those in the foregoing method shown in FIG. 2. Therefore, the same or similar operations may refer to the foregoing description.

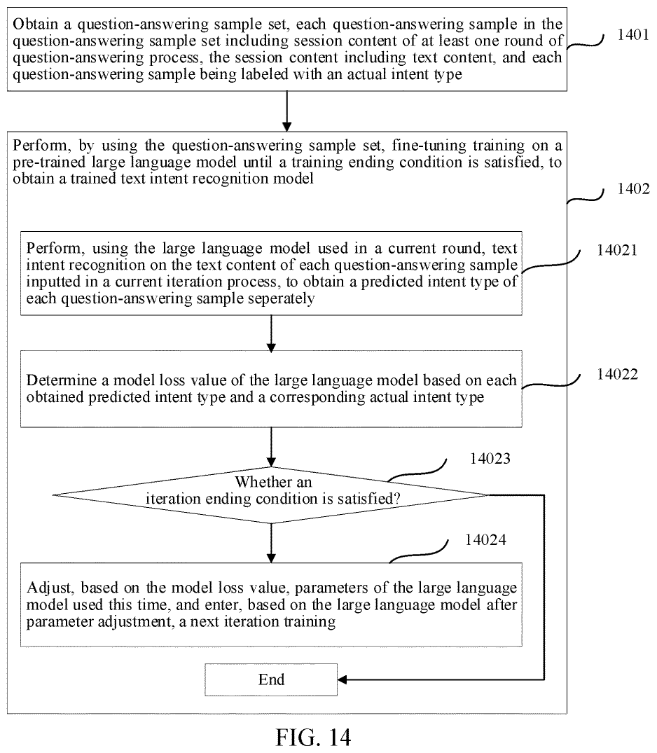

In some embodiments, the text intent recognition process may be performed by using a trained text intent recognition model. Therefore, before performing text intent recognition, model training needs to be performed on the text intent recognition model. Hereinafter, the model training process of the text intent recognition model is described. FIG. 14 is a schematic flowchart of a model training process for a text intent recognition model.

Operation 1401: Obtain a question-answering sample set, each question-answering sample in the question-answering sample set including session content of at least one round of question-answering process, the session content including text content, and each question-answering sample being labeled with an actual intent type.

In some embodiments, the text intent recognition model in some embodiments may be a model obtained by performing SFT based on a large language model pre-trained on a large-scale corpus by using small-scale finely-labeled data, to obtain a model for a task, that is, the text intent recognition model in some embodiments.

Before performing SFT, small-scale finely-labeled training data, that is, a question-answering sample set, needs to be prepared in advance. Each question-answering sample in the question-answering sample set may include session content of at least one round of question-answering process. The session content includes only text content. The content in the question-answering process may be question-answering records of the question-answering process collected from an actual application, and each question-answering sample is labeled with a corresponding actual intent type.

In an implementation, similar to the question-answering sample of the multimodal intent recognition model, corresponding target prompt content may be obtained from the question-answering sample by using a prompt template. Therefore, an actual intent type of a question-answering sample may be considered as a category text generated by using the target prompt content as prompt information. That is, each question-answering sample may be a pair of (multi-round session, intent type label). The multi-round session represents content involved in the question-answering process. The intent type label indicates the actual intent type, and may be understood as an expectation of a text intent recognition result.

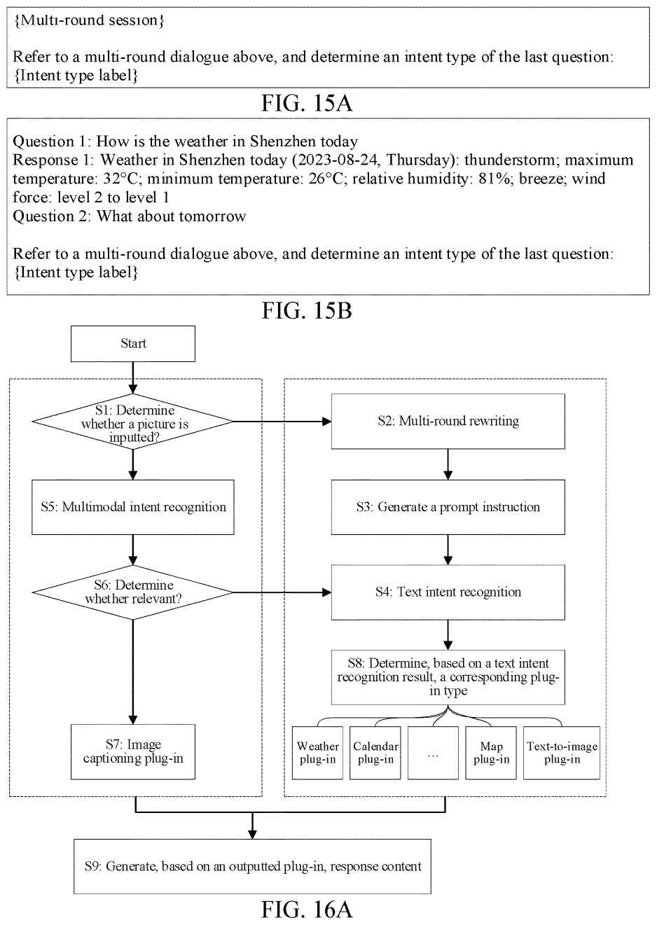

FIG. 15A is an example of a Prompt template in a training stage according to some embodiments. The “multi-round session” is content in a question-answering process, and is used as an input of a model during training. The “intent type label” is used as an output of the model. For example, the intent type label may include “weather”, “map”, “calendar”, or “text-to-image”. In an application stage of the model, prompt content may also be generated according to such a Prompt template. A difference lies in that the Prompt template in the application stage does not include the intent type label.

Exemplarily, as shown in FIG. 15B, content in the question-answering process is concatenated to obtain a question-answering sample, to perform SFT on a large language model. The content of the question-answering process in FIG. 12B is the input of the model. “Question 1” indicates that content belongs to text content including a question, and belongs to a first round of question-answering process. “Response 1” indicates that content belongs to response content, and belongs to the first round of question-answering process, and so on for the rest. The intent type label is an output of the model.

Operation 1402: Perform, by using the question-answering sample set, fine-tuning training on a pre-trained large language model until a training ending condition is satisfied, to obtain a trained text intent recognition model.

The fine-tuning training of the text intent recognition model is similar to that of the foregoing multimodal intent recognition model. Therefore, reference may be made to the foregoing description.

For example, in some embodiments, a model structure used by the text intent recognition model may be any model structure capable of implementing serialized processing, such as a transformer model, a RNN model, an encoder-decoder architecture model, or a GPT series model, so as to fine-tune the model structure based on such a pre-trained model to adapt to the foregoing multimodal intent recognition task.

Since the iteration processes are similar, the following describes one iteration process as an example. During each iteration of the fine-tuning training process, the following operations are performed:

Operation 14021: Perform, using the large language model used in a current round, text intent recognition on the text content of each question-answering sample inputted in a current iteration process, to obtain a predicted intent type of each question-answering sample separately.

During training, an autoregressive language model training mode is used, and an objective is to predict a next token through a current token and tokens before the current token. Since each question-answering sample includes an actual intent type, when performing prediction of the predicted intent type, the model needs to be enabled to perceive only content in the question-answering sample other than the actual intent type and content already predicted, and content not yet predicted in the actual intent type needs to be masked during calculation.

A process of obtaining the actual intent type is a process of decoding input content. Therefore, it may be implemented by using a decoder, for example, a decoder module of a model such as GPT or Transformer. Taking Transformer as an example, its model structure may refer to the structure shown in FIG. 8.

In an example, parameters of the text intent recognition model when using a Transformer decoder may be set as follows:

| Parameter scale | Parameter setting |
|---|---|
| 7B | NUM_LAYERS = 32 |
| | HIDDEN_SIZE = 4096 |
| | NUM_ATTN_HEADS = 32 |
| | FFN_HIDDEN_SIZE = 16384 |
| | ATTN_HEAD_SIZE = 128 |

Operation 14022: Determine a model loss value of the large language model used in the current round based on each obtained predicted intent type and a corresponding actual intent type.

In some embodiments, when the actual intent type is a category text, each category text includes at least one character position. The predicted intent type may be indicated by a probability value set corresponding to each of the at least one character position. Each probability value set includes probability values of a corresponding character position for each candidate character in a candidate character set.

Then, when calculating the model loss value, the calculation may be performed based on the predicted intent type corresponding to the question-answering sample. For example, for one predicted intent type, a sub-loss value corresponding to the predicted intent type may be determined based on a probability value corresponding to a true character for each obtained probability value set. The true character is a character at a corresponding character position in the intent type label. Further, the model loss value may be determined based on each sub-loss value corresponding to each predicted intent type.

For example, a loss function in the SFT stage is consistent with a pre-training stage. For example, a language model may be used to minimize a maximum likelihood function. A possible expression form is as follows:

$${L}_{1} ( U ) = {\sum }_{i} log P ( {u}_{i} \vert {u}_{i - k} , … , {u}_{i - 1} : θ ) ,$$

where U represents a training data set, P indicates a probability of predicting an i^{th} token by using first k tokens, and k indicates a window size. Then, an objective of some embodiments is to maximize a product of conditional probabilities.

In some embodiments, the model loss value may be calculated by using any other possible loss function, for example, a cross entropy loss function, a mean squared error (MSE) loss function, a squared absolute error loss function, or a likelihood loss (LHL) function. Certainly, another possible loss function may be used. This is not limited in some embodiments.

Operation 14023: Determine whether the large language model used in the current round reaches an iteration ending condition.

In some embodiments, the iteration ending condition may include at least one of the following conditions:
(1) A number of iterations reaches a set number threshold.
(2) The model loss value is less than a set loss threshold, or a conditional probability is a maximum value continuously for multiple times, and the like.

Operation 14024: Adjust, if the determination in operation 14023 is negative, based on the model loss value, parameters of the large language model used this time, and enter, based on the large language model after parameter adjustment, a next iteration of training.

In some embodiments, when the number of iterations does not exceed a preset number threshold, and the model loss value is not less than the set loss threshold, the determination in operation 14023 is negative. That is, the current model is considered not to satisfy the iteration ending condition. Then, model parameters need to be adjusted to continue training. After the parameter adjustment, a next iteration of training is entered, that is, the process proceeds to operation 14021.

In some embodiments, when the model still does not satisfy a convergence condition, model weight parameters may be updated by using an optimization algorithm such as a gradient descent method or a stochastic gradient descent algorithm, so as to minimize the foregoing objective function. Training may be continued by using updated model weight parameters, so as to enable the model to better predict a next token.

When the number of iterations has exceeded the preset number threshold, or the model loss value is less than the set loss threshold, the determination in operation 14023 is affirmative. That is, the current model is considered to have satisfied the convergence condition, model training ends, and a trained multimodal model is obtained.

In summary, in the question-answering method provided by some embodiments, based on a pure text intent recognition framework, whether non-text content is relevant to text content is determined through a multimodal intent recognition method. The method is compatible with multimodal intent recognition capability without affecting existing effects of the pure text intent recognition, thereby improving accuracy of response content and being compatible with more usage scenarios.

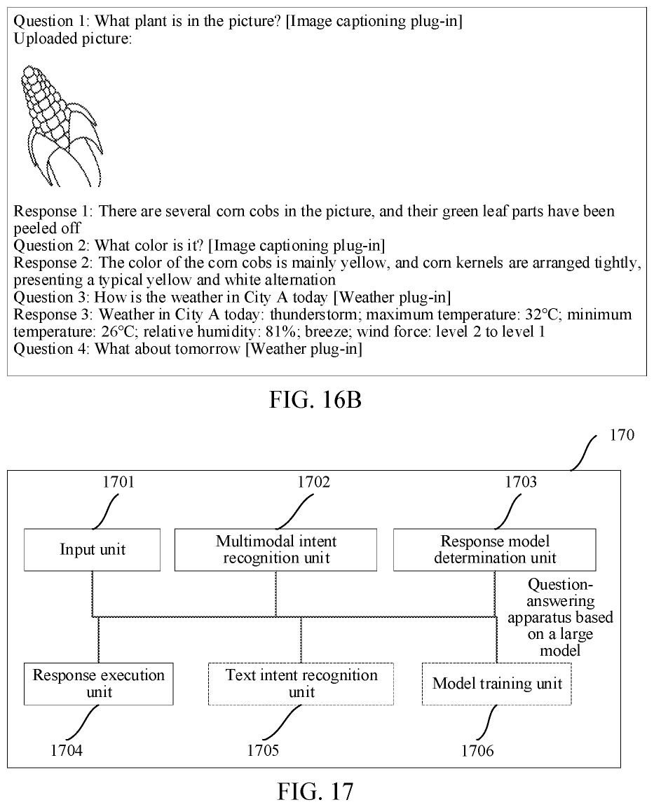

Hereinafter, the technical solution provided by some embodiments is described by way of an example. Herein, description is made by taking an image as the content modality of the non-text content as an example. FIG. 16A is a schematic diagram of a processing flow of a question-answering process. First, operation S1 is performed to determine whether a user inputs a picture. When the user inputs only pure text, a related flow of a pure text link, i.e., flow operations in the right box of FIG. 16A, is performed to output a corresponding plug-in type determined by the pure text link. Herein, a text intent recognition model is used to determine multi-class classification, that is, which one of a weather plug-in, a calendar plug-in, . . . , a map plug-in, a text-to-image plug-in, and the like is used to respond to questions. The pure text link includes performing operation S2. A multi-round rewriting plug-in is invoked to optimize and rewrite current question text. After the rewriting is completed, operation S3 is performed, that is, a Prompt instruction is generated according to a pure text Prompt template. Then, operation S4 is performed, that is, the Prompt instruction is inputted into the text intent recognition model, to obtain a text intent recognition result outputted by the text intent recognition model.

In addition, when the determination in operation S1 is affirmative, that is, the user inputs an image, a related flow of the pure text link and a related flow of a multimodal link are performed in parallel. The related flow of the multimodal link is flow operations in the left box of FIG. 16A, and includes performing operation S5. That is, multimodal intent recognition is performed on session content and the image by the multimodal intent recognition model, to obtain a multimodal intent recognition result outputted by the multimodal intent recognition model. Then, operation S6 is performed to determine whether the multimodal intent recognition result indicates that the session content is relevant to the image. For example, when the multimodal intent recognition result indicates “completely relevant”, operation S7 is directly performed to output an image captioning plug-in. When the multimodal intent recognition result indicates that it belongs to a “basically irrelevant” or “completely irrelevant” type, operation S8 is performed to determine a corresponding plug-in type based on the text intent recognition result.

Finally, operation S9 is performed, and response content is generated based on an outputted plug-in.

Exemplarily, referring to FIG. 16B, in a first round of question-answering process, an image is included, and the image and text content “What plant is in the picture” are apparently completely relevant. Then, an image captioning plug-in shown in FIG. 16B is finally outputted. The image captioning plug-in is used to generate response content, such as the response content shown in FIG. 16B: “There are several corn cobs in the picture, and their green leaf parts have been peeled off”. In a second round of question-answering process, since the image is inputted in the first round, the session content still includes the image, and the image and text content “What color is it” are also completely relevant. Then, the image captioning plug-in shown in FIG. 16B is finally outputted. The image captioning plug-in is used to generate response content, such as the response content shown in FIG. 16B: “The color of the corn cobs may be yellow, and corn kernels are arranged tightly, presenting a yellow and white alternation”. In a third round of question-answering process, the image and text content “How is the weather in City A today” are completely irrelevant. Then, a text intent recognition may be performed based on the text content to determine that a weather plug-in shown in FIG. 16B is finally outputted. The weather plug-in is used to generate response content, such as the response content shown in FIG. 16B: “Weather in City A today: thunderstorm; maximum temperature: 32 °C; minimum temperature: 26 °C; relative humidity: 81%; breeze; wind force: level 2 to level 1”. In the third round of question-answering process, the image and text content “What about tomorrow” are completely irrelevant. Then, the text intent recognition may be performed based on the text content to determine that the weather plug-in shown in FIG. 16B is finally outputted. The weather plug-in is used to generate response content.

In some embodiments, the foregoing text link and multimodal link are divided into different flow processes, and intent recognition is performed by different models. However, in an actual scenario, text intent recognition and multimodal intent recognition may be integrated into one model for processing. This is not limited in some embodiments.

Referring to FIG. 17, based on the same inventive concept, some embodiments further provides a question-answering apparatus 170 based on a large model. The apparatus includes:
an input unit 1701, configured to obtain session content of at least one round of question-answering process, the session content at least including: text content recording a question of a last round of question-answering process;
a multimodal intent recognition unit 1702, configured to perform, when the session content further includes non-text content, multimodal intent recognition on the session content and the non-text content, to obtain a corresponding multimodal intent recognition result, the multimodal intent recognition result indicating a content relevance between the session content and the non-text content;
a response model determination unit 1703, configured to determine, from a candidate response model set based on the multimodal intent recognition result, a matching target response model, each candidate response model in the candidate response model set corresponding to an intent type; and
a response execution unit 1704, configured to obtain response content to a question using the target response model based on the session content and an intent type corresponding to the target response model.

In some embodiments, the apparatus further includes a text intent recognition unit 1705, configured to:
perform, based on context information in the session content, question rewriting on text content, to obtain rewritten text content; and
perform text intent recognition on the session content and the rewritten text content, to obtain a corresponding text intent recognition result.

The response model determination unit 1703 is specifically configured to determine, if the content relevance indicated by the multimodal intent recognition result does not satisfy a preset relevance condition, from a candidate response model subset related to a text modality and included in the candidate response model set based on the text intent recognition result, a matching target response model.

In some embodiments, the response model determination unit 1703 is specifically configured to:
determine, if the content relevance indicated by the multimodal intent recognition result satisfies the preset relevance condition, from a candidate response model subset related to a content modality of the non-text content and included in the candidate response model set, a matching target response model.

In some embodiments, the non-text content includes content respectively corresponding to at least one content modality, and the multimodal intent recognition result indicates a content relevance between each of the at least one content modality and the session content.

The response model determination unit 1703 is specifically configured to:
determine, from the at least one content modality based on the multimodal intent recognition result, a target content modality whose content relevance satisfies the preset relevance condition; and
determine, from a candidate response model subset related to the target content modality, a matching target response model.

In some embodiments, the multimodal intent recognition unit 1702 is specifically configured to:
generate, according to a preset prompt content template and based on the text content and the non-text content in the session content, corresponding target prompt content; and
use the target prompt content as a prompt instruction, and input the prompt instruction into a trained multimodal intent recognition model, to obtain a multimodal intent recognition result outputted by the multimodal intent recognition model.

In some embodiments, the multimodal intent recognition unit 1702 is specifically configured to:
add, according to a chronological order of the at least one round of question-answering process, an attribute label and a round label to the text content in the session content, the attribute label indicating whether corresponding text content is question content or response content, and the round label indicating a question-answering round number corresponding to the corresponding text content;
add a corresponding modality label to the non-text content, the modality label indicating a content modality corresponding to the non-text content; and
combine, according to a preset content sequence in the prompt content template, each piece of labeled content, to obtain the target prompt content.

In some embodiments, the multimodal intent recognition unit 1702 is specifically configured to:
perform the following operations using the multimodal intent recognition model:
encoding, by using a text encoding mode, text content in the target prompt content to obtain a text encoding feature;
encoding, by using a target encoding mode corresponding to a content modality of the non-text content, the non-text content to obtain a non-text encoding feature;
combining the text encoding feature and the non-text encoding feature, to obtain an input encoding feature; and
performing, based on the input encoding feature, multi-round iterative text prediction to obtain an intent recognition result, an output result of a round of text prediction process being obtained based on the input encoding feature and an output result of a previous round.

In some embodiments, the non-text content is an image. The multimodal intent recognition unit 1702 is specifically configured to:
perform image segmentation on the image, to obtain a plurality of image blocks;
perform image encoding on the plurality of image blocks, respectively, to obtain corresponding image block encoding features;
obtain, based on positions of the plurality of image blocks in the image, corresponding position encoding features; and
perform, based on obtained position encoding features, serialized encoding on obtained image block encoding features, to obtain an image encoding feature of the image.

In some embodiments, the apparatus further includes a model training unit 1706, configured to obtain the multimodal intent recognition model through the following training process:
obtaining a question-answering sample set, each question-answering sample in the question-answering sample set including session content of at least one round of question-answering process, the session content including text content and non-text content, and each question-answering sample being labeled with an actual relevance between the session content and the non-text content;
performing, by using the question-answering sample set, fine-tuning training on a pre-trained large language model until a training ending condition is satisfied, the following operations being performed during each iteration round of the fine-tuning training:
performing, using the large language model used in the current round, multimodal intent recognition on the session content and the non-text content in each question-answering sample inputted in a current iteration process, to obtain a predicted relevance between the session content and the non-text content of each question-answering sample separately; and
determining a model loss value of the large language model used in the current round based on the obtained predicted relevances and corresponding actual relevances, and enter, after parameters of the large language model used in the current round are adjusted based on a model loss value, a next iteration of training using a parameter-adjusted large language model.

In some embodiments, a training label is a relevance category text; the relevance category text includes at least one character position; the predicted relevance includes a probability value set corresponding to each of the at least one character position; and each probability value set includes probability values of a corresponding character position for each candidate character in a candidate character set.

The model training unit 1706 is specifically configured to:
perform, for one predicted relevance, the following operations:
determining, based on a probability value corresponding to a true character for each obtained probability value set, a sub-loss value corresponding to the one predicted relevance, the true character being a character at a corresponding character position in a relevance label; and
determining a model loss value based on the sub-loss value corresponding to each predicted relevance.

In some embodiments, the response model determination unit 1703 is configured to:
obtain, based on the content relevance and the session content, actual input content of the last round of question-answering process;
determine, from the candidate response model set, a candidate response model subset matching at least one content modality included in the actual input content; and
determine, from the candidate response model subset, a matching target response model.

By the foregoing apparatus, a content input of multiple content modalities may be supported during a question-answering process, making information expression more diverse, thereby providing richer information to a large model, helping improve accuracy of the large model in understanding input content, generating more accurate response content, and improving accuracy of the response content.

The apparatus may be configured to perform the method shown in some embodiments. Therefore, functions and the like that may be implemented by the functional modules of the apparatus may refer to the descriptions in the foregoing embodiments.

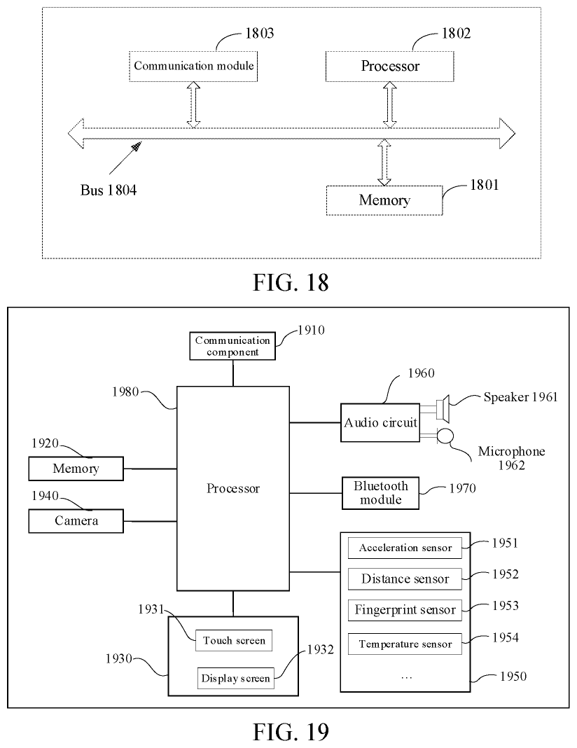

Referring to FIG. 18, based on the same technical concept, some embodiments further provides a computer device. In an embodiment, the computer device may be the server shown in FIG. 1 or the device corresponding to the cloud shown in FIG. 2. The computer device, as shown in FIG. 18, includes a memory 1801, a communication module 1803, and one or more processors 1802.

The memory 1801 is configured to store a computer program executed by the processor 1802. The memory 1801 may mainly include a program storage area and a data storage area. The program storage area may store an operating system, a program for running an instant messaging function, and the like. The data storage area may store various instant messaging information, operation instruction sets, and the like.

The memory 1801 may be a volatile memory, for example, a random-access memory (RAM). The memory 1801 may be a non-volatile memory, for example, a read-only memory, a flash memory, a hard disk drive (HDD), or a solid-state drive (SSD). In some embodiments, the memory 1801 is any other medium that may be configured to carry or store expected program code in a form of an instruction or a data structure and that may be accessed by a computer, but is not limited thereto. The memory 1801 may be a combination of the foregoing memories.

The processor 1802 may include one or more central processing units (CPUs) or digital processing units. The processor 1802 is configured to implement the foregoing question-answering method based on a large model when calling the computer program stored in the memory 1801.

The communication module 1803 is configured to communicate with a terminal device or other servers.

A connecting medium between the foregoing memory 1801, the communication module 1803, and the processor 1802 is not limited in some embodiments. In some embodiments, as shown in FIG. 18, the memory 1801 is connected to the processor 1802 via a bus 1804. The bus 1804 is depicted by a thick line in FIG. 18. The connection modes between other components are merely illustrative and are not intended to be limiting. The bus 1804 may be classified as an address bus, a data bus, a control bus, or the like. For ease of description, only one thick line is for describing the bus in FIG. 18, but this does not mean that there is only one bus or only one type of bus.

The memory 1801 has a computer storage medium stored therein, the computer storage medium has computer-executable instructions stored therein, and the computer-executable instructions are configured for implementing the question-answering method based on a large model in some embodiments. The processor 1802 is configured to perform the question-answering method based on a large model of the foregoing embodiments.

In another embodiment, the computer device may be a terminal device, such as the terminal device shown in FIG. 1. In this embodiment, a structure of the computer device may be shown in FIG. 19, including components such as a communication component 1910, a memory 1920, a display unit 1930, a camera 1940, a sensor 1950, an audio circuit 1960, a Bluetooth module 1970, and a processor 1980.

The communication component 1910 is configured to communicate with a server. In some embodiments, a circuit wireless fidelity (WiFi) module may be included. The Wi-Fi module belongs to a short distance wireless transmission technology, and the computer device may help a user transmit and receive information through the WiFi module.

The memory 1920 may be configured to store software programs and data. The processor 1980 executes various functions and data processing of the terminal device by running the software program or data stored in the memory 1920. The memory 1920 may include a high-speed random access memory, or may include a non-volatile memory, for example, at least one magnetic disk storage device, a flash memory device, or another volatile solid-state storage device. The memory 1920 has an operating system stored therein that enables the terminal device to run. In this application, the memory 1920 may store the operating system and various application programs, and may further store code for performing the question-answering method based on a large model in some embodiments.

The display unit 1930 may be further configured to display information inputted by a user or information provided to the user, and a graphical user interface (GUI) of various menus of the terminal device. Specifically, the display unit 1930 may include a display screen 1932 arranged on the front surface of the terminal device. The display screen 1932 may be configured in a form of a liquid crystal display, a light emitting diode, and the like. The display unit 1930 may be configured to display a session page in some embodiments.

The display unit 1930 may be further configured to receive inputted digit or character information, and generate a signal input related to a user setting and function control of the terminal device. Specifically, the display unit 1930 may include a touchscreen 1931 disposed on the front of the terminal device, which may collect touch operations of the user on or near the touchscreen, for example, tapping a button and dragging a scroll box.

The touchscreen 1931 may cover the display screen 1932, or the touchscreen 1931 and the display screen 1932 may be integrated to implement an input function and an output function of the terminal device, which may be referred to as a touch display screen after integration. In this application, the display unit 1930 may display the application program and corresponding operating operations.

The camera 1940 may be configured to capture a static image, and the user may issue the image captured by the camera 1940 through the application. There may be one or a plurality of cameras 1940. An optical image of an object is generated through a lens and is projected onto a photosensitive element. The photosensitive element may be a charge coupled device (CCD) or a complementary metal-oxide-semiconductor (CMOS) phototransistor. The photosensitive element converts an optical signal into an electrical signal, and then transfers the electrical signal to the processor 1980 for conversion into a digital image signal.

The terminal device may further include at least one sensor 1950, for example, an acceleration sensor 1951, a distance sensor 1952, a fingerprint sensor 1953, and a temperature sensor 1954. The terminal device may further be configured with other sensors such as a gyroscope, a barometer, a hygrometer, a thermometer, an infrared sensor, an optical sensor, and a motion sensor.

The audio circuit 1960, a speaker 1961, and a microphone 1962 may provide an audio interface between the user and the terminal device. The audio circuit 1960 may transmit an electrical signal converted from received audio data to the speaker 1961, and the speaker 1961 converts the electrical signal into a sound signal for output. The terminal device may be further configured with a volume button, configured to adjust a volume of the sound signal. In addition, the microphone 1962 converts a collected sound signal into an electrical signal, and the audio circuit 1960 receives the electrical signal, converts the electrical signal into audio data, and then outputs the audio data to the communication component 1910 for transmission to, for example, another terminal device, or outputs the audio data to the memory 1920 for further processing.

The Bluetooth module 1970 is configured to exchange, through a Bluetooth protocol, information with another Bluetooth device having the Bluetooth module. For example, the terminal device may establish, by using the Bluetooth module 1970, a Bluetooth connection to a wearable computer device (for example, a smartwatch) that also has a Bluetooth module, thereby performing data interaction.

The processor 1980 is a control center of the terminal device that connects various parts of the entire terminal by using various interfaces and lines. The processor 1980 performs various functions of the terminal device and processes data by running or executing the software program stored in the memory 1920 and invoking the data stored in the memory 1920. In some embodiments, the processor 1980 may include one or more processing units. The processor 1980 may integrate an application processor and a baseband processor. The application processor mainly processes the operating system, a user interface, the application program, and the like, and the baseband processor mainly processes wireless communication. In some embodiments, the foregoing baseband processor may not be integrated into the processor 1980. The processor 1980 in this application may run an operating system, an application program, a user interface display and touch response, and the question-answering method based on a large model in some embodiments. In addition, the processor 1980 is coupled with the display unit 1930.

Based on the same inventive concept, some embodiments further provides a storage medium. The storage medium has a computer program stored therein. The computer program, when run on a computer, causes the computer to perform the operations in the question-answering method based on a large model described above in the specification according to various exemplary implementations of this application.

In some possible implementations, various aspects of the question-answering method based on a large model provided in this application may be further implemented in a form of a computer program product. The computer program product includes a computer program. When the program product is run on a computer device, the computer program is configured for causing the computer device to perform the operations in the question-answering method based on a large model described above in the specification according to various exemplary implementations of this application. For example, the computer device may perform the operations in the embodiments.

The program product may use any combination of one or more readable media. The readable medium may be a readable signal medium or a readable storage medium. The readable storage medium may be, for example, but is not limited to, an electric, magnetic, optical, electromagnetic, infrared, or semiconductor system, apparatus, or device, or any combination of the above. More examples (a non-exhaustive list) of the readable storage medium include an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination of the above.

The program product of the implementation of this application may use a CD-ROM, include a computer program, and be run on the computer device. However, the program product in this application is not limited thereto. In this document, the readable storage medium may be any tangible medium including or storing a program, and the computer program included in the readable storage medium may be used by or in combination with a command execution system, apparatus, or device.

The readable signal medium may include a data signal propagated in a baseband or as part of a carrier wave. The data signal carries a readable computer program. A data signal propagated in such a way may have a plurality of forms, including but not limited to, an electromagnetic signal, an optical signal, or any appropriate combination of the above. The readable signal medium may be any readable medium other than a readable storage medium, and the readable medium may be configured to send, propagate, or transmit a program used by or in combination with an instruction execution system, an apparatus, or a device.

The computer program included in the computer medium may be transmitted by using any suitable medium, including but not limited to wireless, wired, optical cable, RF, and the like, or any suitable combination of the above.

The computer program configured to perform the operations in this application may be compiled by using one or more programming languages or any combination thereof. The programming languages include object-oriented programming languages such as Java and C++, and further include conventional procedural programming languages such as a “C” language or similar programming languages.

Although several units or subunits of an apparatus are mentioned in the above detailed descriptions, the division is merely exemplary rather than mandatory. Actually, based on the implementations of this application, features and functions of the two or more units described above may be specified in one unit. On the contrary, the features and functions of one unit described above may be further divided into a plurality of units to be specified.

In addition, although operations of the method in this application are described in a order in the accompanying drawings, this does not require or imply that the operations need to be performed in the order, or that all the operations shown need to be performed, to achieve an expected result. Additionally, or In some embodiments, some operations may be omitted, multiple operations may be combined into one operation for execution, and/or one operation may be decomposed into multiple operations for execution.

A person skilled in the art needs to understand that some embodiments may be provided as a method, a system, or a computer program product. Therefore, this application may use a form of the entirely hardware embodiments, the entirely software embodiments, or the embodiments combining software and hardware aspects. Moreover, this application may use a form of a computer program product that is implemented on one or more computer-usable storage media (including but not limited to a disk memory, a CD-ROM, an optical memory, and the like) that include a computer-usable program code.

Technical features of the foregoing embodiments may be combined in different manners to form other embodiments. In order to make the description concise, not all the possible combinations of various technical features in the foregoing embodiments are described. However, the combinations of these technical features are to be considered as falling within the scope of the description as long as there is no contradiction therein. Although preferred some embodiments have been described, a person skilled in the art may make other changes and modifications to these embodiments once a inventive concept is known. Therefore, the appended claims are intended to be interpreted as including the preferred embodiments and all changes and modifications falling within the scope of this application.

It will be apparent to a person skilled in the art that various modifications and variations may be made to this application without departing from the spirit and scope of this application. Thus, if such modifications and variations of this application fall within the scope of the claims of this application and equivalents thereof, this application also includes such modifications and variations.

What is claimed is:

1. A question-answering data processing method based on a large model, performed by a computer device, the method comprising:
obtaining session content of at least one round of a question-answering process, the session content comprising text content recording a question of a last round of the question-answering process;
determining, based on the session content comprising non-text content, a content relevance between the text content and the non-text content;
determining, based on the content relevance satisfying a preset relevance condition, a target response model from a candidate response model set, the target response model matching a content modality of the non-text content;
generating response content to the question using the target response model based on the session content; and
outputting the response content for presentation on a session interface of the computer device.

2. The method according to claim 1, further comprising:
recognizing an intent type of the text content; and
determining, based on the content relevance not satisfying the preset relevance condition, from a candidate response model subset related to a text modality and in the candidate response model set, the target response model matching the intent type of the text content.

3. The method according to claim 1, wherein
the determining the content relevance between the text content and the non-text content comprises:
determining, based on the non-text content comprising content respectively corresponding to at least one content modality, a respective content relevance between the content corresponding to each content modality of the at least one content modality and the text content; and
the determining of the target response model comprises:
determining, from the at least one content modality, at least one target content modality for which the respective content relevance satisfies the preset relevance condition; and
determining, from the candidate response model set, the target response model matching the at least one target content modality.

4. The method according to claim 1, wherein the determining of the target response model comprises:
determining, from a candidate response model subset related to the content modality of the non-text content and in the candidate response model set, the target response model matching an intent type of the session content.

5. The method according to claim 1, wherein the determining the content relevance between the text content and the non-text content comprises:
organizing, according to a preset prompt content template, the text content and the non-text content into a prompt instruction; and inputting the prompt instruction into a multimodal intent recognition model to obtain the content relevance output by the multimodal intent recognition model.

6. The method according to claim 5, wherein the organizing comprises:
adding, according to a chronological order of the at least one round of the question-answering process, an attribute label and a round label to the text content, the attribute label indicating whether a portion of the text content to which the attribute label is added is question content or response content, and the round label indicating a question-answering round number corresponding to the portion of the text content to which the round label is added;
adding a corresponding modality label to the non-text content, the modality label indicating a content modality of the non-text content; and
combining, according to a preset content sequence in the prompt content template, each piece of labeled content to obtain the prompt instruction.

7. The method according to claim 5, wherein the inputting comprises:
performing the following operations using the multimodal intent recognition model:
encoding, by using a text encoding mode, the text content in the prompt instruction into a text encoding feature;
encoding, by using an encoding mode corresponding to the content modality of the non-text content, the non-text content into a non-text encoding feature;
combining the text encoding feature and the non-text encoding feature into an input encoding feature; and
performing, based on the input encoding feature, multi-round iterative text prediction to obtain the content relevance, an output result of each round of the multi-round iterative text prediction being obtained based on the input encoding feature and an output result of a previous round.

8. The method according to claim 7, wherein the non-text content is an image; and
the encoding of the non-text content into the non-text encoding feature comprises:
segmenting the image into a plurality of image blocks;
encoding each image block of the plurality of image blocks into a respective image block encoding feature;
obtaining, based on a position of each image block of the plurality of image blocks in the image, a respective position encoding feature of each image block; and
performing, based on the respective position encoding features of the plurality of image blocks, serialized encoding on the respective image block encoding features of the plurality of image blocks to obtain the non-text encoding feature as an image encoding feature of the image.

9. The method according to claim 5, wherein the multimodal intent recognition model is obtained through the following training process:
obtaining a question-answering sample set, each question-answering sample in the question-answering sample set comprising sample session content of at least one round of a question-answering process, the sample session content comprising sample text content and sample non-text content, and each question-answering sample being labeled with an actual relevance between the sample session content and the sample non-text content;
performing, by using the question-answering sample set, fine-tuning training on a pre-trained large language model until a training ending condition is satisfied, the following operations being performed during each iteration round of the fine-tuning training:
recognizing, using the large language model, a predicted relevance between the sample text content and the sample non-text content in each question-answering sample inputted in the iteration round; and
determining a model loss value based on the obtained predicted relevances and corresponding actual relevances, and adjusting, based on the model loss value, parameters of the large language model.

10. The method according to claim 9, wherein the actual relevance is a relevance category text; the relevance category text comprises at least one character position; the predicted relevance comprises a probability value set corresponding to each of the at least one character position; and each probability value set comprises probability values of a corresponding character position for each candidate character in a candidate character set; and
the determining of the model loss value comprises:
performing, for each predicted relevance of the obtained predicted relevances, the following operations:
determining, based on a probability value corresponding to a true character for each obtained probability value set, a sub-loss value corresponding to the predicted relevance, the true character being a character at a corresponding character position in the relevance category text; and
determining the model loss value based on the sub-loss value corresponding to each predicted relevance.

11. The method according to claim 1, wherein the determining of the target response model comprises:
obtaining, based on the content relevance and the session content, input content associated with the last round of the question-answering process;
determining, from the candidate response model set, a candidate response model subset matching at least one content modality included in the input content; and
determining, from the candidate response model subset, the target response model.

12. A question-answering data processing apparatus based on a large model, comprising:
at least one memory configured to store program code; and
at least one processor configured to read the program code and operate as instructed by the program code, the program code comprising:
obtaining code configured to cause at least one of the at least one processor to obtain session content of at least one round of a question-answering process, the session content comprising text content recording a question of a last round of the question-answering process;
relevance code configured to cause at least one of the at least one processor to determine, based on the session content comprising non-text content, a content relevance between the text content and the non-text content;
selection code configured to cause at least one of the at least one processor to determine, based on the content relevance satisfying a preset relevance condition, a target response model from a candidate response model set, the target response model matching a content modality of the non-text content;
generation code configured to cause at least one of the at least one processor to generate response content to the question using the target response model based on the session content; and
output code configured to cause at least one of the at least one processor to output the response content for presentation on a session interface of the computer device.

13. The apparatus according to claim 12, wherein the program code further comprises:
intent code configured to cause at least one of the at least one processor to recognize an intent type of the text content; and
wherein the selection code is further configured to cause at least one of the at least one processor to determine, based on the content relevance not satisfying the preset relevance condition, from a candidate response model subset related to a text modality and in the candidate response model set, the target response model matching the intent type of the text content.

14. The apparatus according to claim 12, wherein
the relevance code is further configured to cause at least one of the at least one processor to:
determine, based on the non-text content comprising content respectively corresponding to at least one content modality, a respective content relevance between the content corresponding to each content modality of the at least one content modality and the text content; and
wherein the selection code is further configured to cause at least one of the at least one processor to:
determine, from the at least one content modality, at least one target content modality for which the respective content relevance satisfies the preset relevance condition; and
determine, from the candidate response model set, the target response model matching the at least one target content modality.

15. The apparatus according to claim 12, wherein the selection code is further configured to cause at least one of the at least one processor to:
determine, from a candidate response model subset related to the content modality of the non-text content and in the candidate response model set, the target response model matching an intent type of the session content.

16. The apparatus according to claim 12, wherein the relevance code is further configured to cause at least one of the at least one processor to:
organize, according to a preset prompt content template, the text content and the non-text content into a prompt instruction; and
input the prompt instruction into a multimodal intent recognition model to obtain the content relevance output by the multimodal intent recognition model.

17. The apparatus according to claim 16, wherein the relevance code is further configured to cause at least one of the at least one processor to:
add, according to a chronological order of the at least one round of the question-answering process, an attribute label and a round label to the text content, the attribute label indicating whether a portion of the text content to which the attribute label is added is question content or response content, and the round label indicating a question-answering round number corresponding to the portion of the text content to which the round label is added;
add a corresponding modality label to the non-text content, the modality label indicating a content modality of the non-text content; and
combine, according to a preset content sequence in the prompt content template, each piece of labeled content to obtain the prompt instruction.

18. The apparatus according to claim 16, wherein the relevance code is further configured to cause at least one of the at least one processor to perform the following operations using the multimodal intent recognition model:
encode, by using a text encoding mode, the text content in the prompt instruction into a text encoding feature;
encode, by using an encoding mode corresponding to the content modality of the non-text content, the non-text content into a non-text encoding feature;
combine the text encoding feature and the non-text encoding feature into an input encoding feature; and
perform, based on the input encoding feature, multi-round iterative text prediction to obtain the content relevance, an output result of each round of the multi-round iterative text prediction being obtained based on the input encoding feature and an output result of a previous round.

19. The apparatus according to claim 18, wherein the non-text content is an image; and
the relevance code is further configured to cause at least one of the at least one processor to:
segment the image into a plurality of image blocks;
encode each image block of the plurality of image blocks into a respective image block encoding feature;
obtain, based on a position of each image block of the plurality of image blocks in the image, a respective position encoding feature of each image block; and
perform, based on the respective position encoding features of the plurality of image blocks, serialized encoding on the respective image block encoding features of the plurality of image blocks to obtain the non-text encoding feature as an image encoding feature of the image.

20. A non-transitory computer-readable storage medium, storing computer code which, when executed by at least one processor, causes the at least one processor to at least:
obtain session content of at least one round of a question-answering process, the session content comprising text content recording a question of a last round of the question-answering process;
determine, based on the session content comprising non-text content, a content relevance between the text content and the non-text content;
determine, based on the content relevance satisfying a preset relevance condition, a target response model from a candidate response model set, the target response model matching a content modality of the non-text content;
generate response content to the question using the target response model based on the session content; and output the response content for presentation on a session interface of the computer device.
